(19) United States
(12) Patent Application Publication
(10) Pub. No.: US 2014/0119020 A1
(43) Pub. Date: May 1, 2014

(54) Smart Illuminator For Retroreflective Display Device

(71) Applicant: ELWHA LLC, Bellevue, WA (US)

(72) Inventors: William D. Duncan, Kirkland, WA (US); Roderick A. Hyde, Redmond, WA (US); Muriel Y. Ishikawa, Livermore, CA (US); Jordin T. Kare, Seattle, WA (US); Lowell L. Wood, JR., Bellevue, WA (US)

(73) Assignee: ELWHA LLC, Bellevue, WA (US)

(21) Appl. No.: 13/663,668

(22) Filed: Oct. 30, 2012

(51) Int. Cl. F21V 14/00

(52) U.S. Cl. CPC F21V 14/00
USPC 362/276

(57) ABSTRACT

Method and apparatus features are implemented in a visual display system to provide coordinated interaction between an independent light source and a proximate retroreflective display. The light rays output characteristics of the independent light source are adjusted (e.g., by a controller) based on predetermined and/or detected viewing parameters of the retroreflective display. The retroreflected rays are targeted back toward an eye of a user associated with the independent light source to provide improved brightness and contrast for screen viewing by the user. Some retroreflective display screen embodiments may also include a self-illuminating mode as well as other non-retroreflective illumination modes of operation.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

NONE

### RELATED APPLICATIONS

U.S. patent application Ser. No. 13/______ entitled ENHANCED RETROREFLECTIVE DISPLAY DEVICE, naming William D. Duncan, Roderick A. Hyde, Muriel Y. Ishikawa, Jordin T. Kare, Lowell L. Wood, Jr. as inventors, filed 30 Oct. 2012 with attorney docket no. 1009-009-002-000000, is related to the present application.

U.S. patent application Ser. No. 13/______ entitled HYBRID RETROREFLECTIVE DISPLAY DEVICE, naming William D. Duncan, Roderick A. Hyde, Muriel Y. Ishikawa, Jordin T. Kare, Lowell L. Wood, Jr. as inventors, filed 30 Oct. 2012 with attorney docket no. 1009-009-003-000000, is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

The present application relates to methods, devices, apparatus and optical systems regarding retroreflective screen viewing devices and related illumination units that are operably linked together for coordinated usage.

### SUMMARY

In one aspect, an exemplary illumination method for retroreflective displays may include activating an independent light source for illuminating one or more types of retroreflective displays; and modifying at least one operating characteristic of the independent light source pursuant to analysis by a controller associated with the independent light source, wherein the analysis is based on a known or determined specified feature of a proximate retroreflective display.

In another aspect, an exemplary retroreflective illumination method may include activating a light source, determine a characteristic of a proximate retroreflective display, and controlling at least one operating characteristic of the light source in response to the determined characteristic of the proximate retroreflective display.

In one or more various aspects, related systems and apparatus include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

In another aspect, an exemplary illumination system includes but is not limited to computerized components regarding optical illumination techniques for a retroreflective display, which system has the capability to implement the various process features disclosed herein. Examples of various system and apparatus aspects are described in the claims, drawings, and text forming a part of the present disclosure.

Some exemplary illumination systems for use with retroreflective displays may include an independent light source capable of illuminating one or more types of retroreflective displays, and a controller associated with the independent light source and configured to modify at least one operating characteristic of the independent light source in response to a known or determined specified feature of a proximate retroreflective display.

Other exemplary illumination systems for use with a retroreflective display may include a light source; and a controller adapted to determine a characteristic of the retroreflective display, wherein the controller is configured to control at least one operating characteristic of the light source in response to the characteristic of the retroreflective display.

A further example of a retroreflective viewing system for a visual display may include means for activating an independent light source, means for determining a characteristic viewing factor of a proximate retroreflective display, and controller means for adjusting at least one operating characteristic of the independent light source in response to the determined characteristic of the proximate retroreflective display.

In a further aspect, a computer program product embodiment includes computer-readable media having encoded instructions for executing an illumination method that may include enabling an independent light source to provide light rays output for illuminating a proximate retroreflective display, and implementing a modification of at least one operating characteristic of the independent light source based on a known or determined specified feature of the proximate retroreflective display.

In another aspect, a computer program product embodiment includes computer-readable media having encoded instructions for executing a retroreflective illumination method that may include activating a light source, determining a characteristic of a proximate retroreflective display, and controlling at least one operating characteristic of the light source in response to the determined characteristic of the proximate retroreflective display.

In addition to the foregoing, various other method and/or system and/or program product aspects are set forth and described in the teachings such as text (e.g., claims and/or detailed description) and/or drawings of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic block diagram illustrating exemplary embodiment features for a retroreflective screen display that is operatively linked with different types of separate independent light sources.

FIG. 2 is a schematic block diagram illustrating additional exemplary embodiment features for an enhanced retroreflective illuminator unit.

FIGS. 3-4 are schematic diagrams depicting exemplary light source embodiments capable of providing retroreflective illumination for proximate display devices having different sizes or shapes or dimensions or orientations.

FIG. 5 is a schematic block diagram illustrating examples of operational correlation between an enhanced illuminator and a retroreflective display device.

FIG. 6 is schematic block diagram illustrating further examples of operational correlation regarding a retroreflective display and its independent light source.

FIG. 7 is a high level flow chart that shows exemplary techniques for controlling operating parameters of a retroreflective viewing system.

FIGS. 8-13 are detailed flow charts illustrating further exemplary aspects applicable to retroreflective screen viewing embodiments.

FIG. 14 is a high level flow chart showing additional exemplary techniques for operational correlation between a retroreflective display and a proximate independent light source.

FIG. 15 is a diagrammatic flow chart for exemplary computer-readable media embodiment features.

FIG. 16 is a schematic block diagram illustrating another exemplary embodiment that includes an enhanced retroreflective display device.

FIG. 17 is a high level schematic block diagram illustrating exemplary embodiment features for coordinating a remote light source with a retroreflective display.

FIGS. 18-19 are additional schematic block diagrams illustrating exemplary system features for different types of mobile retroreflective system components.

FIG. 20 is a high level flow chart showing further exemplary aspects regarding a retroreflective display viewing system.

FIGS. 21-28 are detailed flow charts illustrating additional exemplary aspects applicable to retroreflective screen viewing embodiments.

FIG. 29 is a diagrammatic flow chart for further exemplary computer-readable media embodiment features.

FIG. 30 depicts an exemplary data table for different viewing factors applicable to different identified users of one or more retroreflective screen devices.

FIGS. 31-32 are schematic diagrams depicting examples of retroreflective and specular techniques which may be incorporated in visual displays that provide enhanced brightness and contrast for a user or observer situated at various preferred locations relative to an external illumination source.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences.

In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The various embodiment features disclosed herein are capable of compatible implementation with any type of retroreflective display having at least one operating mode in which data (e.g., text or images) is displayed at least partly via spatially-varying retroreflective gain. One example of such a retroreflective display is a variably-transmissive display such as a liquid crystal display (LCD) which incorporates an at least partly retroreflective layer behind (i.e., on a side away from the viewer) the LCD pixels. Another example of such a retroreflective display is a Gyricon e-paper display employing electrostatically rotatable particles, in which at least some particles comprise retroreflectors that are visible when the “white” side of the particle is displayed. Yet another example is a micro-electro-mechanical (MEMS) display, in which pixels are switched from retroreflective to non-retroreflective by physical motion of a moveable micromirror.

Some retroreflective display embodiments, as disclosed herein, may also operate in a non-retroreflective mode including without limitation an emissive mode, a backlit transmissive mode, a specular variably reflective mode, or a diffuse variably-reflective mode, or any combination of such modes. Exemplary emissive mode embodiments include a cathode ray tube (CRT), plasma display, organic light emitting diode (OLED). An example of a backlit transmissive mode is a backlit LCD. An example of a specular variably reflective mode is a micromirror display. Examples of a diffuse variably-reflective mode include a Gyricon display, electrophoretic display electrowetting display, reflective LCD, etc. A self-illuminating mode is any mode in which the display provides its own light, including an emissive mode or backlit transmissive mode.

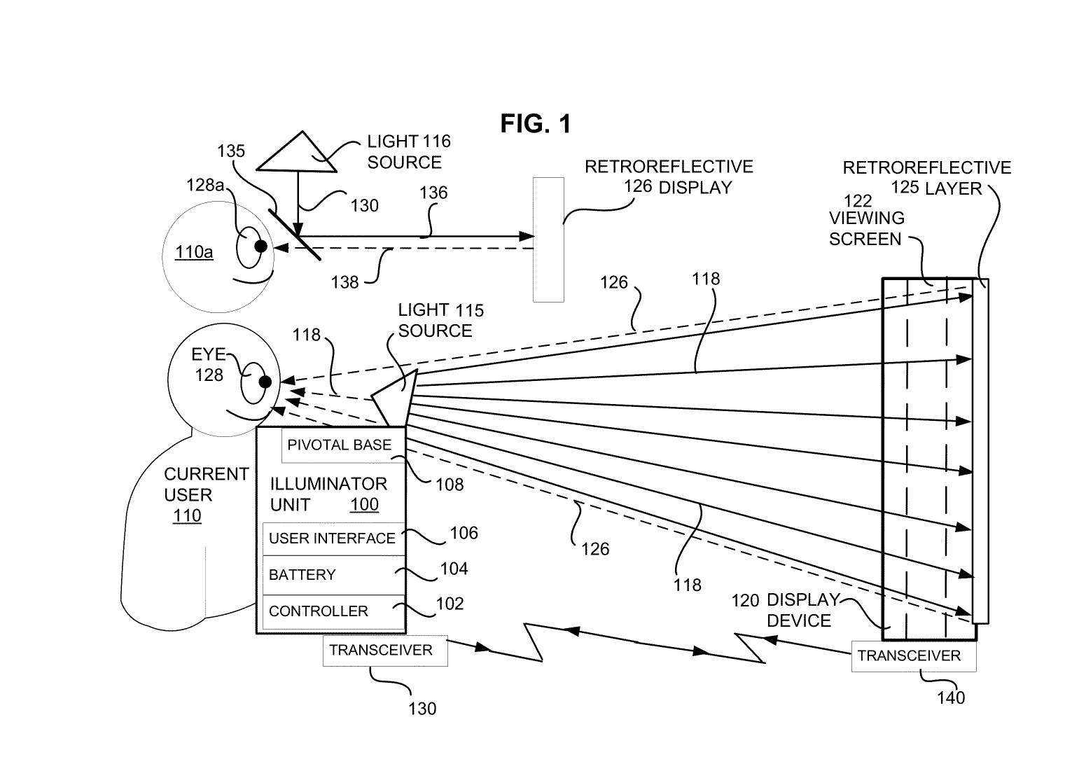

The schematic block diagram of FIG. 1 illustrates exemplary embodiment features for possible retroreflective displays (see 120, 126) that may be operatively linked with different types of independent light sources (see 115, 116). For example an illuminator unit 100 is configured to be capable of operative connection with a display device 120 that may include a viewing screen 122 having a retroreflective component (e.g., layer 125). The illuminator unit 100 may include controller 102, battery 104 or other power source, and user interface 106 accessible to a current user 110 positioned adjacent to an independent light source 115 that enables enhanced viewing by at least one eye 128 of images or alphanumeric information displayed on the viewing screen 122.

The independent light source 115 associated with the illuminator unit 100 may include one or more individual light emitting elements configured to direct light rays 118 toward the retroreflective layer 125 in a manner to return retroreflected light rays 126 of a specific geometry back to an area primarily around the eye 128 of the current user 110. Various mechanically adjustable directional components may be incorporated with the illuminator unit 100 (e.g., see pivotal base 108) for mounting the independent light source 115. The controller 102 may be operably linked to the pivotal base 108 and/or to certain optical elements (not shown) associated with the independent light source 115 to direct the illumination toward the display device.

The independent light source 115 (and in some instances the related illuminator unit 100) may be attached and/or supported directly on a portion of the user's head or arms or body. Some embodiments may enable such attachment and/or support on a clothing item or other accoutrement adjacent the user. Various exemplary embodiments may include an independent light source physically located to be integral with or alternatively to be separate and apart from the other illuminator components (e.g., controller 102, battery 104, user interface 106) associated with the current user 110 depending on the circumstances.

A bidirectional communication link is provided in this illustrated example between the illuminator unit 100 and the proximate display device 120 to enable wireless signal transmissions between an illuminator transceiver 130 and a display transceiver 140. Such transmissions may facilitate initial detection and operational matchup between an illuminator unit 110 and the proximate display device 120. Modulated signal transmissions via the communication link may control apparent brightness for the user based on adjustment of intensity and/or directional and/or angular distribution characteristics of light rays output transmitted from the independent light source 115 toward the retroreflective layer 125.

In view of the various embodiment features disclosed herein, it will be understood that satisfactory retroreflective illumination (e.g., apparent brightness and contrast for the display device field of view of the user) of a variable transmissive viewing screen 122 may preferably be accomplished in some environments without need of a backlight panel or other internal light source, and despite the presence of scattered light from extraneous sources. Similarly, satisfactory retroreflective illumination of a variably reflective or variably scattering display such as an e-paper display may be achieved without additional external lighting.

A further illustrated example in FIG. 1 shows a current user 110a positioned relative to a light source 116 that directs light rays output 130 toward a reflector 135 positioned for optical alignment with a proximate retroreflective display 126. Based on a determination of the viewing parameters of the retroreflective display 126, the operating characteristics of the light source 116 as well as reflector 135 may be adjusted to achieve a desired optical gain for light rays 136 transmitted to the retroreflective display 126 and reflected back (see 138) to an eye 128a of the current user 110a. It will be understood that light source 116 may include one or more light emitting elements (e.g., LEDs, laser), as well as other types of light sources (e.g., fiber optic link, free space optical path, scattered light capture/focus elements) as a basis for providing such light rays output 130.

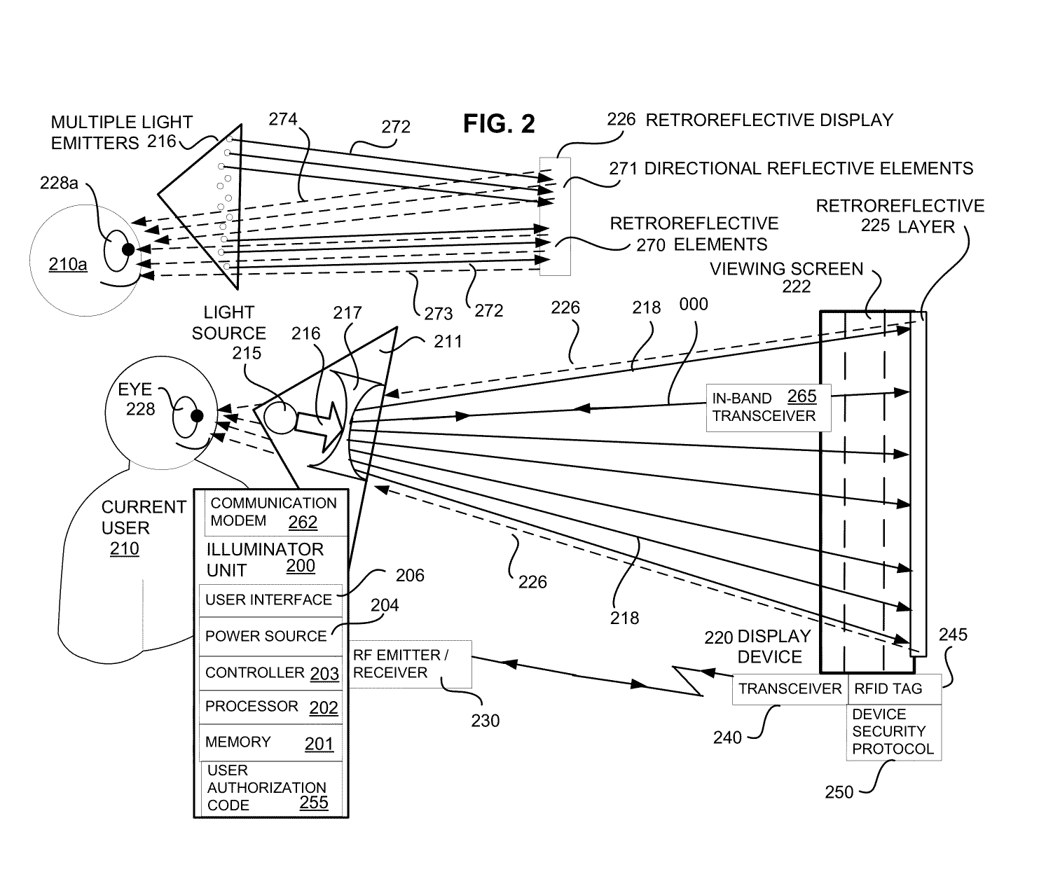

Referring to the schematic block diagram of FIG. 2 which illustrates additional exemplary embodiment features, an enhanced illuminator unit 200 may be configured to be capable of operative correlation with a display device 220 having a viewing screen 222 and a retroreflective layer 126. The illuminator unit 200 may include memory 201, processor 202, controller 203, power source 204 (e.g., battery) as well as a user interface 206 accessible to a current user 210 who is positioned for retroreflective viewing of images or alphanumeric information displayed on the viewing screen 222.

An independent light source 215 on the illuminator unit 200 is adapted to direct light rays 216 via an optical component (e.g., lens 217) toward viewing screen 222 to send retroreflected light rays 226 back to an area primarily around an eye 228 of the current user 210. Other optical elements may also be incorporated with the illumination unit 211 to achieve for the current user 210 a desired brightness and/or contrast for a field of view of the viewing screen 222 under various ambient light conditions. In the embodiment depicted in FIG. 2, a mounting bracket 217 for the independent light source 215 may be in relatively fixed position relative to a user. However other embodiments may be adapted to provide movable and/or pivotal and/or rotational real-time adjustment of the light source and or its related optical components to achieve the desired intensity and/or directionality and/or angular distribution of the output light rays.

In some embodiments it may be desirable in implement directional control of output light rays from the illumination unit via reflection or diffraction or refraction techniques. In other embodiment such directional control of output light rays is achieved by physical positioning as well as realignment of optical elements or light emitting elements.

Another possibility may include selective activation of different combinations of multiple light emitting elements (e.g. an LED array). For example, a user 210a may be associated with an independent light source that includes multiple light emitters 216 (e.g. LED array) configured to direct light rays (e.g. 272) toward a retroreflective display 226. In this embodiment certain retroreflected light rays 273 can be sent back to a geometric area that includes an eye 228a of user 210a by retroreflective elements 270. Additional brightness and/or contrast may be provided by employing directional reflective elements 271 rather than pure retroreflectors. Such elements may be tuned for sending reflective rays 274 in a direction that increases the retroreflected light intensity at a predetermined viewing location of the eye 228a relative to the light source. Control of the operating characteristics of the independent light source elements 216 also enables more efficient screen illumination when the ambient light conditions are not conducive for providing sufficient illumination from scattered light rays.

Various types of communication links may be provided between the illuminator unit 200 and the display device 220. For example certain light rays generated or transmitted from independent light source 215 may be modulated (e.g., time division multiplexing, peripheral rays, etc.) by a communication modem 262 for having a transmission link to an in-band transceiver 265 of the display device 220 for purposes of sending/receiving informational data and/or a status request and/or a control command. Another possible communication link with a display device transceiver 240 may be implemented via a radio frequency (RF) emitter/receiver incorporated with the illuminator unit 200. In some instances the display device 220 may include a radio frequency identification tag (see RFID 245) in order to establish proper identification and location of the display device 220 relative to the illuminator unit 200.

As an optional feature, it may be desirable in some embodiments to prevent or discourage unauthorized usage of the display device 220. For example the illuminator unit 200 in some instances may include a user authorization code 255 which can be recognized pursuant to signal transmissions between the illuminator unit 200 and the display device 220 in accordance with a device security protocol 250. In that regard activation of the independent light source 215 would be dependent upon detection of the display device being located proximate to the illuminator unit, as well as confirmation of the user authorization code 255 associated with the illuminator unit 200 and/or the current user 210.

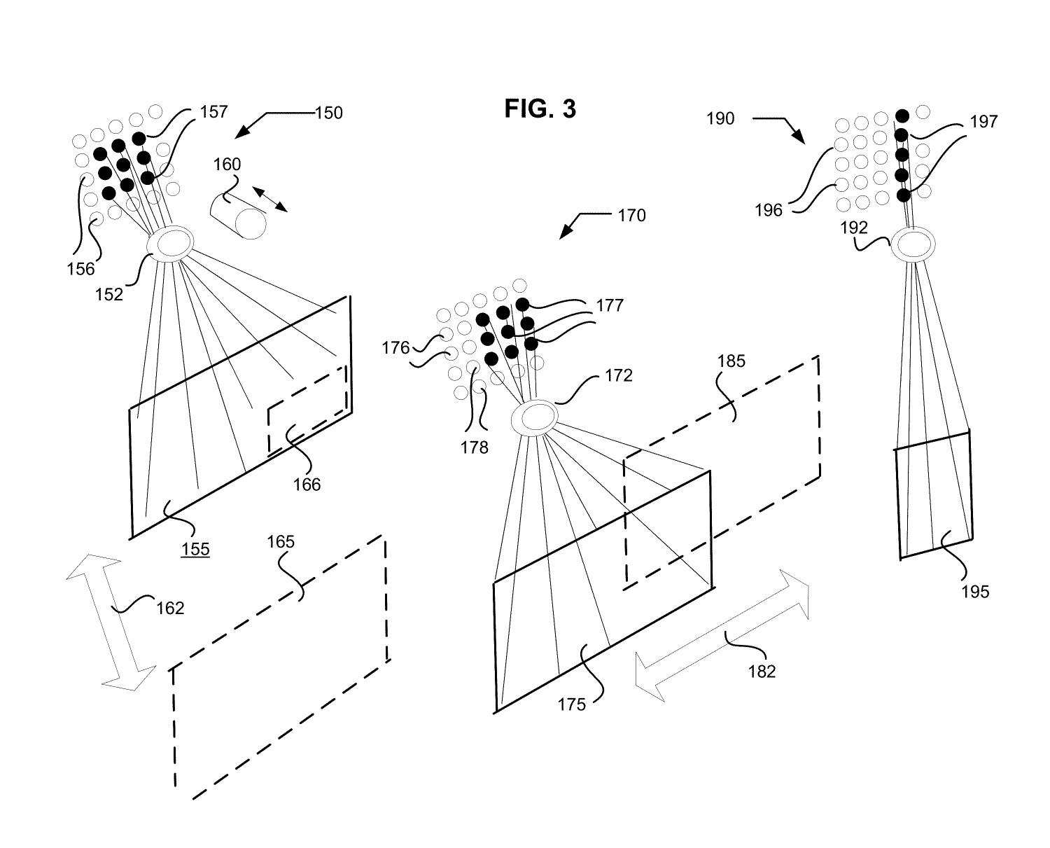

Various exemplary illumination features for retroreflective displays are shown in FIG. 3 including illuminator units 150, 170, 190 that include a light source adapted for retroreflective illumination of a proximate visual display. The illuminator units 150, 170, 190 includes an array of light emitting elements (e.g., LEDs) capable of selective activation in a pattern that correlates with a size or shape or dimension or orientation of respective retroreflective displays 155, 175, 195.

For example a controller module (see FIGS. 1-2) can be configured to selectively activate certain light emitting elements (e.g., see highlighted activated elements 157 as compared to dormant elements 156) that direct light rays output through a lens 152 toward a fixed position retroreflective display 155. It will be understood that different patterns of activated light elements may be selected for illumination of a smaller display screen (e.g., see 166) as well as a full-size display screen 165 located at different viewing distances 162 relative to the separated light source. Some embodiments may include additional optical components (e.g., see zoom lens 160) to provide controlled adjustment of the light rays output based on different viewing distances for a user associated with the light source.

Some embodiments may include a controller module adapted to provide automatic real-time adjustment responsive to relative movement between the separated light source and the retroreflective display. For example see illuminator unit 170 that includes an array of light emitting elements aligned with lens 172, wherein a pattern of activated light emitting elements (see highlighted activated elements 177) along one side of an LED array compensates for lateral movement 182 of retroreflective display 175 in a first direction. In the event of lateral movement in an opposite direction to a new location (see 185), some non-aligned light emitting elements are turned off, and previously dormant light emitting elements (e.g., see 176, 178) along a different side of the LED array may be activated to prevent any lapse of adequate retroreflective screen illumination.

Other embodiments are adapted to compensate for extreme dimensional changes incorporated in different types of display screens. For example, see illuminator unit 190 that includes an array of light emitting elements aligned with lens 192, wherein a narrow vertical column of activated light elements 197 are activated to correlate with a smaller rectangular retroreflector display 165 often found in small hand-held tablets or cell phone displays. As previously indicated, some previously dormant light elements (e.g., see 196) may be activated as necessary to accommodate realignment of the light ray output responsive to movement of the retroreflector display 165 in different directions as well as responsive to repositioned orientation relative to the LED retroreflective illumination array.

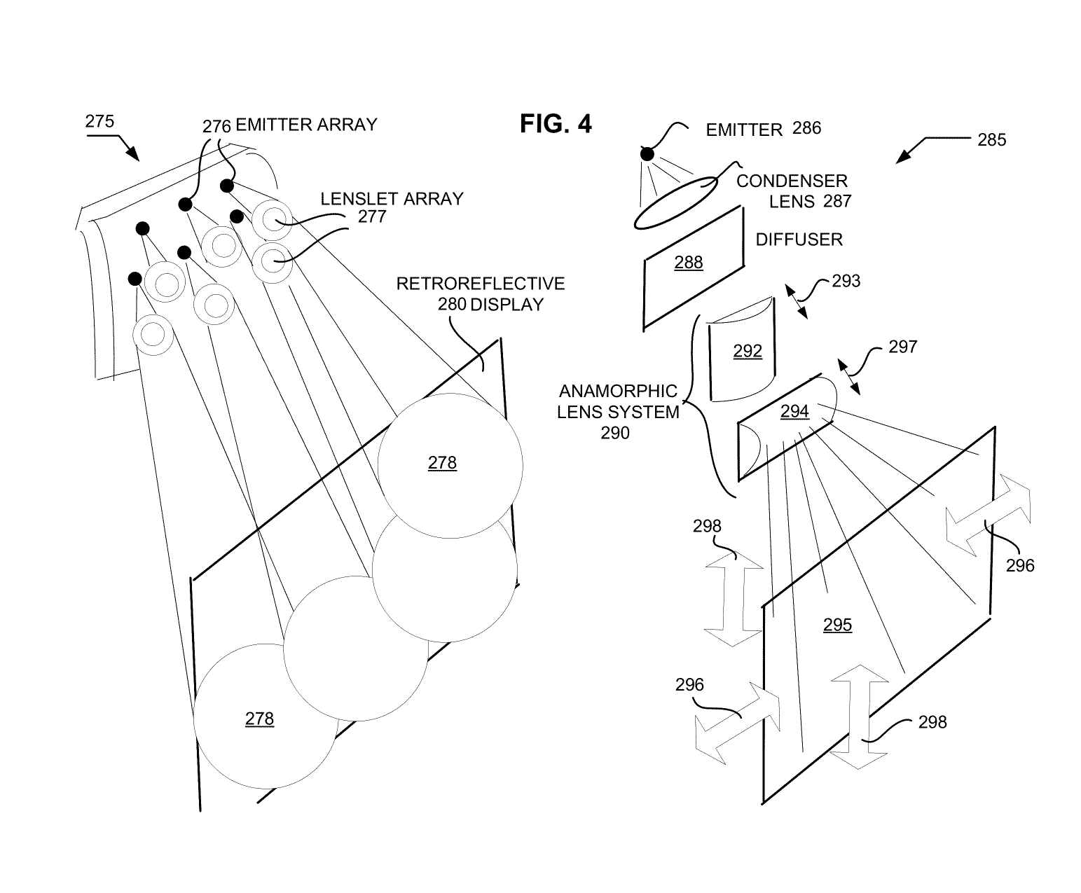

Referring to the schematic diagram of FIG. 4, an exemplary illumination unit 275 includes an emitter array 276 and a matching lenslet array 277 adapted and positioned for respective optical individual optical axis alignment to achieve illumination (e.g., see partially overlapping beam patterns 278) of an entire retroreflective display 280. Of course, as previously described regarding the embodiment features of FIG. 3, a controller can be configured for selective activation of appropriate patterns of individual light emitting elements to accommodate retroreflective displays having different sizes and shapes and dimensions as well as to accommodate variable viewing distances and movement of the retroreflective displays relative to a light source mounted adjacent a display device user.

Another illustrated exemplary embodiment depicted in FIG. 4 includes a light emitter 386 for generating light rays output passing through condenser lens 287 and diffuser 288 toward an anamorphic lens system 290 to achieve illumination of an entire screen portion of retroreflective display 295. A first longitudinally adjustable optical component 292 is configured to expand or contract the output light rays in a horizontal direction 296, and a second longitudinally adjustable optical component 294 is configured to expand or contract the output light rays in a vertical direction 298 to match a periphery of the retroreflective display 295. Such output light beam adjustments may be implemented to establish a default setting during a viewing period for a fixed retroreflective display illuminated by a stationary external light source, as well as in some instances enabling real-time adjustments to compensate for relative movement (e.g., viewing distance changes, etc.) caused by a moving light source (e.g., attached to a user's head) or a moving retroreflective display (e.g., a handheld screen device).

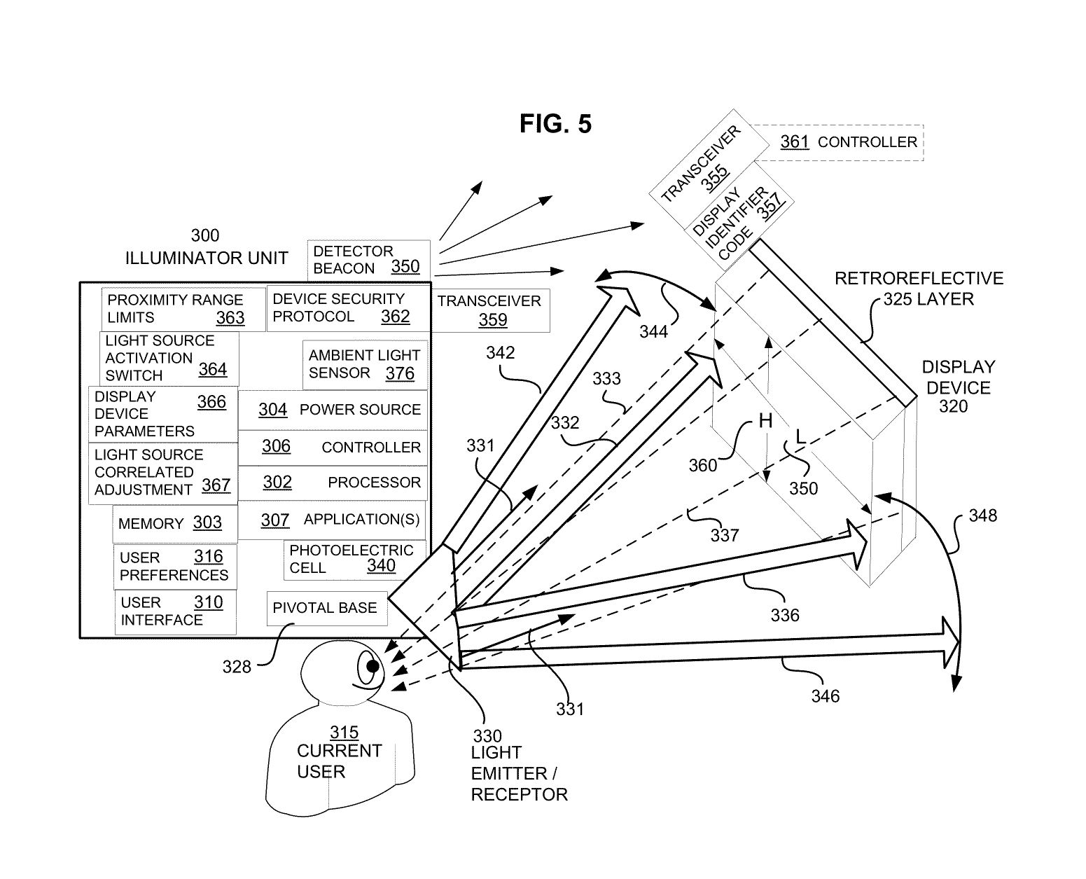

The schematic block diagram of FIG. 5 shows various examples of operational interaction between an enhanced illuminator unit 300 and a display device 320 having a retroreflective layer 325. Possible components incorporated with the illuminator unit 300 include processor 302, memory 303, power source 304, controller 306, one or more applications 307, and a user interface accessible to a current user 315. A bidirectional wireless communication link may be provided between an illuminator unit transceiver 359 and a display device transceiver 355 for transmission of informational data and/or status requests and/or control commands relating to coordinated operation of the illuminator unit 200 and the display device 220. Some system implementations may include controller 361 incorporated with the display device 320 for processing such transmissions and implementing various functions of the display device for the benefit of the current user 315.

A light emitter/receptor 330 is configured to direct light rays in various directions toward the display device 320. In that regard the light rays 332, 336 which are scanned laterally along a length “L” 350 direction of the display device 320 will be reflected back from the retroreflective layer 325 in a manner to be detected by the receptor function (e.g., photoelectric cell 340, optical detection) of the light emitter/receptor 330. The controller 306 is adapted to process such reflected rays (e.g., see 333, 337) to establish a dimension parameter for the length “L” 350 of the display device and its coterminous retroreflective layer 325. A height dimension “H” 360 can similarly be determined by detection of light rays which are scanned vertically and reflected back from the retroreflective layer for detection by the receptor function (e.g., photoelectric cell 340, optical detection) of the light emitter/receptor 330.

A distinct perimeter boundary can be determined by sensing that light rays 342 scanned laterally outside a left peripheral edge (e.g., see 344) of the retroreflective layer 325 will not be reflected back toward the light emitter/receptor 330. A further distinct perimeter boundary can be determined by sensing that light rays 346 scanned laterally outside a right peripheral edge (e.g., see 346) of the retroreflective layer 325 will not be reflected back toward the light emitter receptor 330. Similar techniques can be used with respect to the top and bottom peripheral edges of the retroreflective layer 325.

The aforesaid specific illustrations regarding scanning techniques are provided only as examples, and are not intended to be limiting. Generally speaking it will be understood that various scanning patterns, for example raster, spiral, or edge-following scans may be employed to determine the angular size, shape and orientation of the display area. In some embodiments two scanning devices may be employed to determine distance by parallax measurement. Of course other means for detecting the size, shape, distance or orientation of the display area will be apparent to those skilled in the art in view of the exemplary disclosures herein.

Additional communication and/or detection regarding the display device parameters may be implemented by a separate detector beacon 350 configured for transmission of out-of-band infrared (IR) or ultraviolet (UV) non-visible optical rays as well as in some embodiments the transmission of ultrasound signals or radio frequency (RF) signals.

As illustrated in FIG. a5, a possible optional security safeguard feature may be provided in some embodiments pursuant to data processing by controller 306 regarding a user authorization code 356 as well as a display identifier code 357 which may be recognized and confirmed via signal processing in accordance with a device security protocol 362. Of course it will be understood that some retroreflective viewing systems may be configured to enable implementation of user preferences that are predetermined or selected in real-time without any requirement for security safeguards or user authorization procedures.

Proximity determination between the illuminator unit 300 (and in some instances its independent light source) as compared to a location of the display device 320 (and in some instances its retroreflective layer) can be implemented pursuant to the aforesaid interactive signal processing. Various guidelines may determine proximity range limits 364 as a basis for manual or automatic control of light source activation switch 366. Also various predetermined and/or detected and/or calculated display device parameters 372 can provide a basis for various types of correlated light source operational adjustment 374.

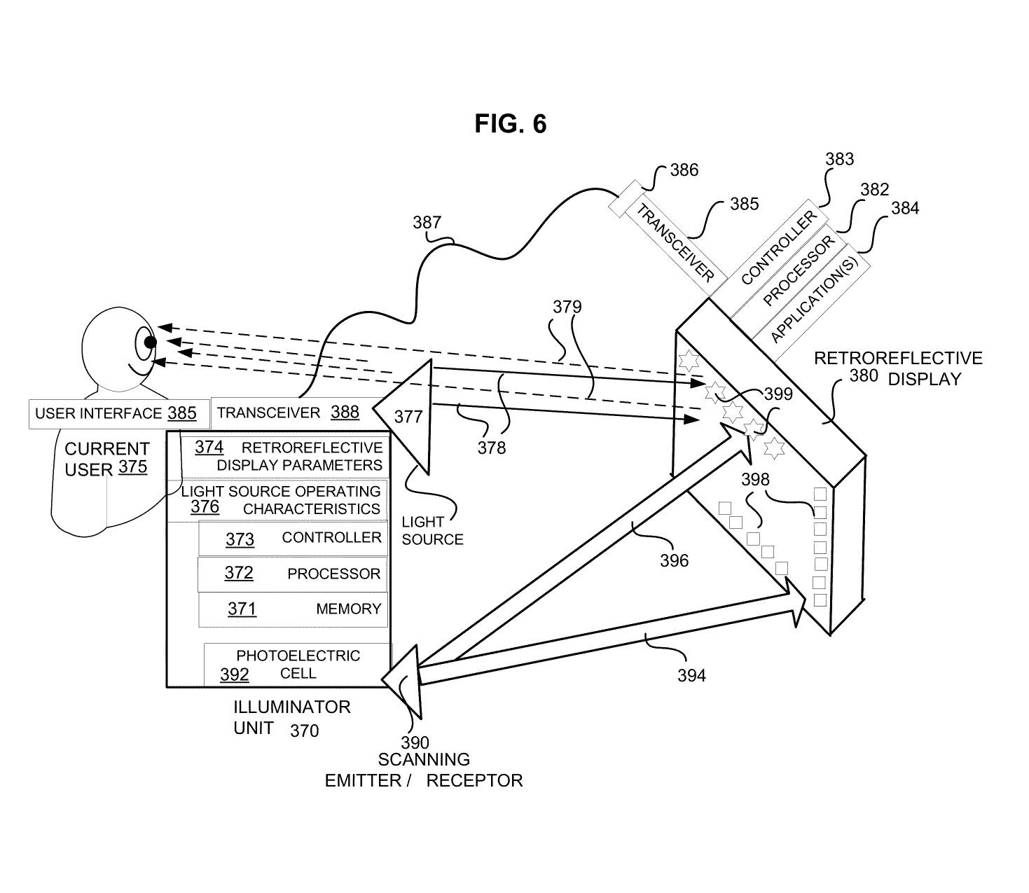

The schematic block diagram of FIG. 6 illustrates further exemplary techniques for operational correlation between a retroreflective display 380 and an illuminator unit 370 having a light source 377. The light rays output 378 from the light source 377 are directed toward the proximate retroreflective display 380 in a manner to send back retroreflected rays 279 in an angular distribution pattern around a user's eye that provides brightness and/or contrast for screen viewing by the current user 375. A possible embodiment for the illuminator unit includes memory 371, processor 372, controller 373, and user interface 385 for the current user 375.

The illuminator unit may also include updatable data records for retroreflective display parameters 374 and updatable data records for light source operating characteristics 376. A communication link (e.g., wire connection 387) is provided for bidirectional signal transmission between transceiver 388 incorporated with illuminator unit 30 and a communication bus 386 for transceiver 385 incorporated with the proximate retroreflective display 380. Such modulated signal transmissions may include directional and/or dimensional and/or spectral data regarding the proximate retroreflective display 380, which data can be processed by controller 373 to provide a basis for adjusting the light source operating characteristics 376.

As another example, perimeter data indicating a size or shape or dimension of the retroreflective display may be determined by sensing retroreflected rays from distinctive (e.g., by gain or spectral properties) retroreflective elements 399 positioned around a periphery of the retroreflective display 380. In some embodiments, similar perimeter data may be determined by a distinctive set of color pixels 398 positioned around a periphery of a viewing screen of the retroreflective display 380. Both types of optical perimeter indicators are detectable by directional scanning 394, 396 of a scan emitter/receptor 390 linked to photoelectric cell 392 or other optical detection component. Other techniques may be used for such detection of shapes and dimensions and perimeter data, and the examples are only provided for purposes of illustration and are not intended to be limiting.

In some instances, data processing to determine a correlation between retroreflective display parameters of the retroreflective display 380 and the light source operating characteristics 376 may be performed by processor 382, controller 383 and one or more applications 384 associated or incorporated with the retroreflective display 380.

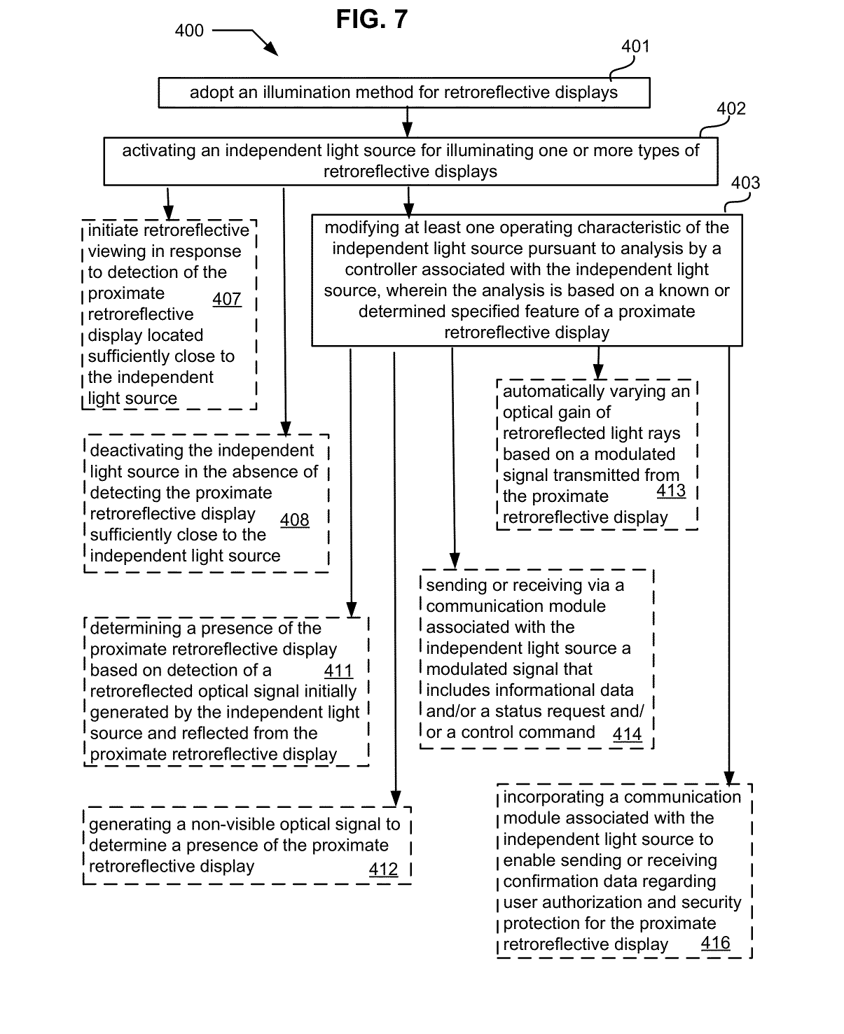

Referring to embodiment features 400 shown in the high level flow chart of FIG. 7, an adopted illumination method for retroreflective displays 401 may include activating an independent light source for illuminating one or more types of retroreflective displays (block 402); and modifying at least one operating characteristic of the independent light source pursuant to analysis by a controller associated with the independent light source, wherein the analysis is based on a known or determined specified feature of a proximate retroreflective display (block 403). Another exemplary process feature includes determining a presence of the proximate retroreflective display based on detection of a retroreflected optical signal initially generated by the independent light source and reflected from the proximate retroreflective display (block 411).

In some instances an exemplary embodiment may initiate retroreflective viewing in response to detection of the proximate retroreflective display located sufficiently close to the independent light source (block 407), and deactivating the independent light source in the absence of detecting the proximate retroreflective display sufficiently close to the independent light source (block 408). Another related aspect may include generating a non-visible optical signal to determine a presence of the proximate retroreflective display (block 412).

Further possible aspects shown in FIG. 7 include automatically varying an optical gain of retroreflected light rays based on a modulated signal transmitted from the proximate retroreflective display (block 413). An additional possible process aspect includes sending or receiving via a communication module associated with the independent light source a modulated signal that includes informational data and/or a status request and/or a control command (block 414). Some exemplary embodiment features include incorporating a communication module associated with the independent light source to enable sending or receiving confirmation data regarding user authorization and security protection for the proximate retroreflective display (block 416).

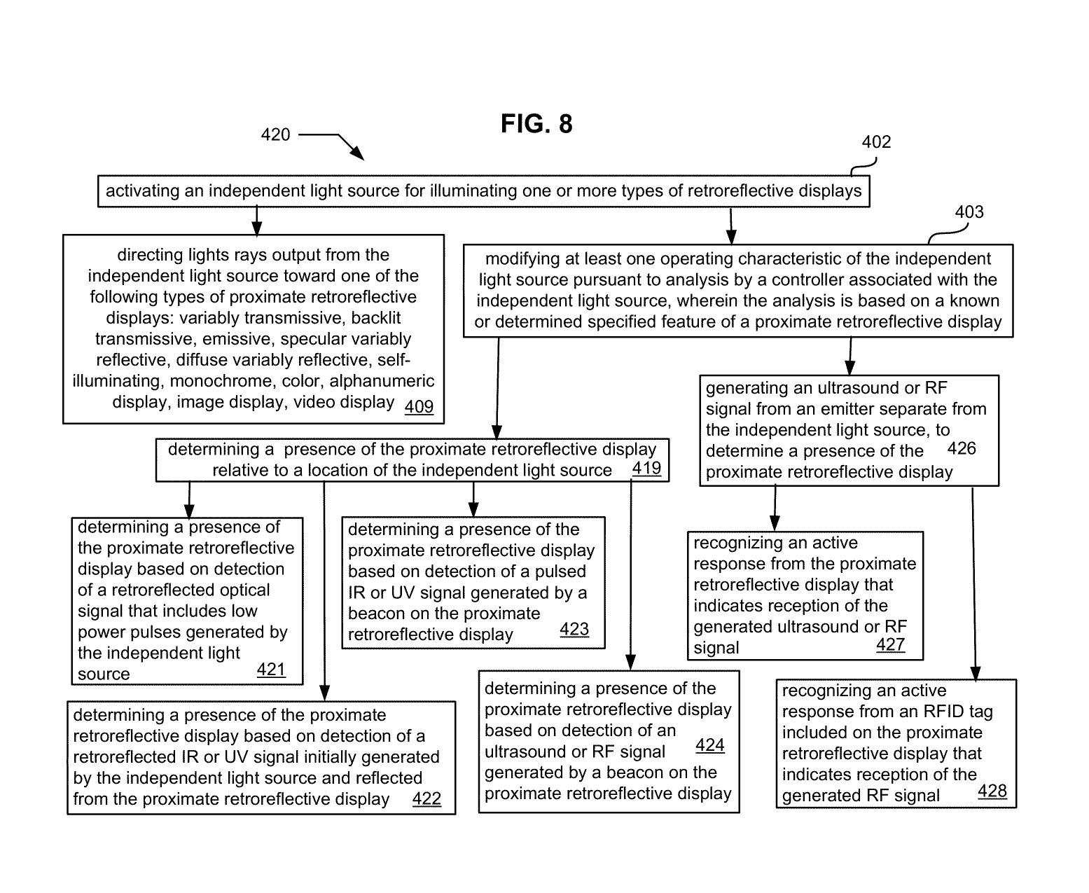

The flow chart of FIG. 8 illustrates further process embodiment features 420 that include previously described aspects 402, 403 in combination with determining a presence of the proximate retroreflective display relative to a location of the independent light source (block 419). Related examples include determining a presence of the proximate retroreflective display based on detection of a retroreflected optical signal that includes low power pulses generated by the independent light source (block 421), or in some embodiments such determination is based on detection of a retroreflected IR or UV signal initially generated by the independent light source and reflected from the proximate retroreflective display (block 422).

Other process features may include determining a presence of the proximate retroreflective display based on detection of a signal (e.g., pulsed IR or UV) generated by a beacon on the proximate retroreflective display (block 423). Further possible examples include determining a presence of the proximate retroreflective display based on detection of an ultrasound or RF signal generated by a beacon on the proximate retroreflective display (block 424).

Additional process examples illustrated in FIG. 8 include generating an ultrasound or RF signal from an emitter separate from the independent light source, to determine a presence of the proximate retroreflective display (block 426). Another example includes recognizing an active response from the proximate retroreflective display that indicates reception of the generated ultrasound or RF signal (block 427). A further possibility includes recognizing an active response from an RFID tag included on the proximate retroreflective display that indicates reception of the generated RF signal (block 428).

Other process examples include directing lights rays output from the independent light source toward one of the following types of proximate retroreflective displays: variably transmissive, backlit transmissive, emissive, specular variably reflective, diffuse variably reflective, self-illuminating, monochrome, color, alphanumeric display, image display, video display (block 409).

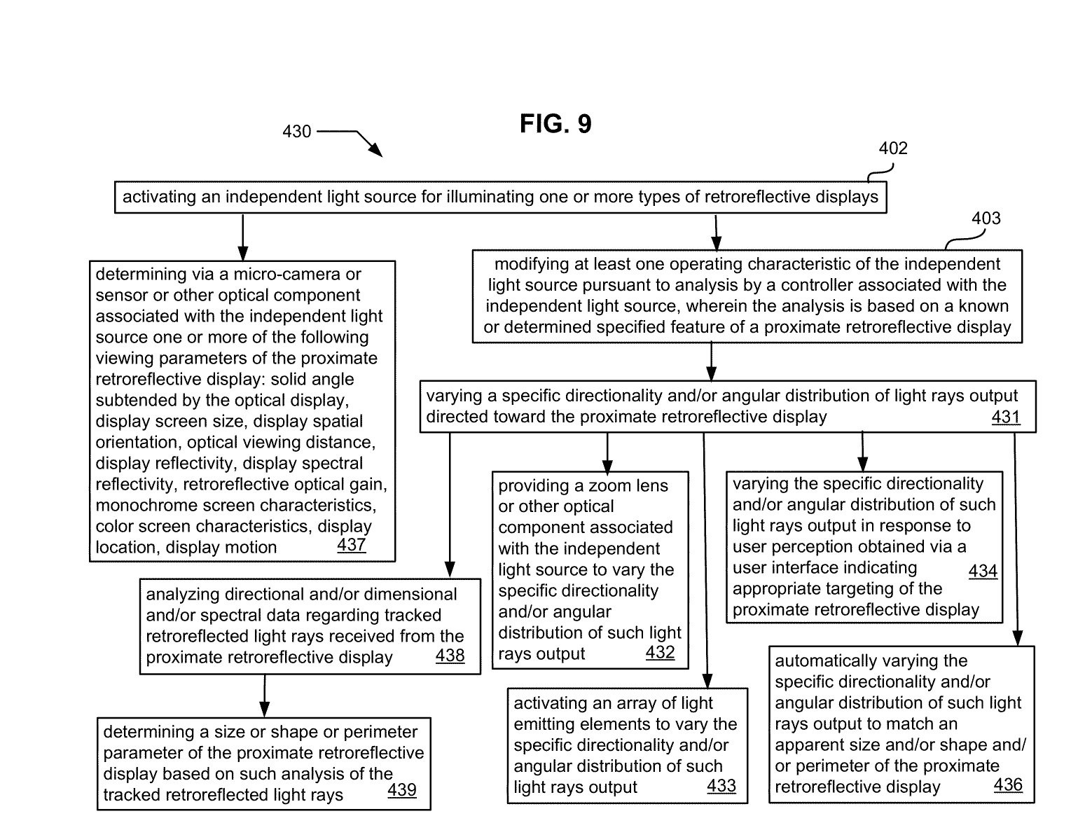

FIG. 9 shows various embodiment features 430 that include previously described aspects 402, 403 as well as varying a specific directionality and/or angular distribution of light rays output of the independent light source (block 431). Additional examples include providing a zoom lens or other optical component associated with the independent light source to vary the specific directionality and/or angular distribution of such light rays output. (block 432), or in some instances activating an array of light emitting elements to vary the specific directionality and/or angular distribution of the light rays output (block 433).

Another example includes varying the specific directionality and/or angular distribution of the light rays output in response to user perception obtained via a user interface indicating appropriate targeting of the proximate retroreflective display (block 434). Further process enhancements may include automatically varying the specific directionality and/or angular distribution of the light rays output to match an apparent size and/or shape and/or perimeter of the proximate retroreflective display (block 436).

Additional process possibilities include determining via a micro-camera or sensor or other optical component associated with the independent light source one or more of the following viewing parameters of the proximate retroreflective display: solid angle subtended by the optical display, display screen size, display spatial orientation, optical viewing distance, display reflectivity, display spectral reflectivity, retroreflective optical gain, monochrome screen characteristics, color screen characteristics, display location, display motion (block 437). Related aspects may include analyzing directional and/or dimensional and/or spectral data regarding tracked retroreflected light rays received from the proximate retroreflective display (block 438). A further related aspect includes determining a size or shape or perimeter parameter of the proximate retroreflective display based on such analysis of the tracked retroreflected light rays (block 439).

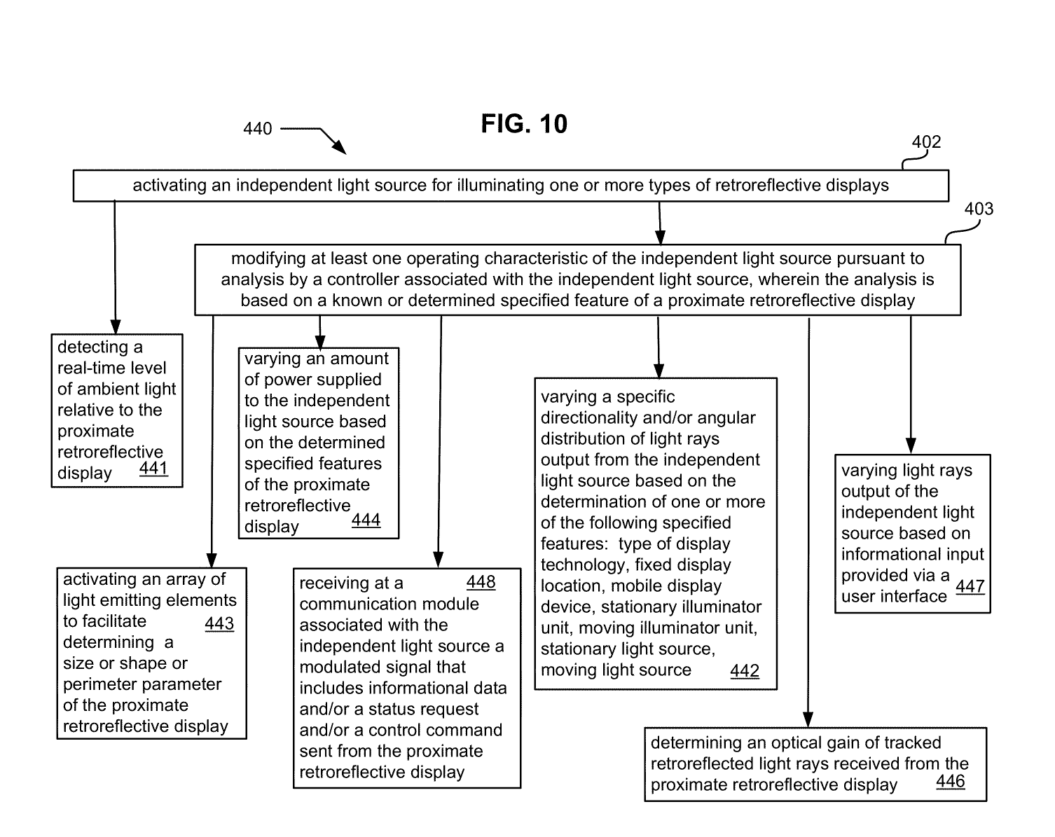

The detailed flow chart of FIG. 10 illustrates embodiment features 440 that include previously described process aspects 402, 403 along with varying a specific directionality and/or angular distribution of light rays output from the independent light source based on the determination of one or more of the following specified features: type of display technology, fixed display location, mobile display device, stationary illuminator unit, moving illuminator unit, stationary light source, moving light source (block 442). Some process embodiments may include detecting a real-time level of ambient light relative to the proximate retroreflective display (block 441).

Another illustrated process feature includes determining an optical gain of tracked retroreflected light rays received from the proximate retroreflective display (block 446). Another example includes varying an amount of power supplied to the independent light source based on the determined specified features of the proximate retroreflective display (block 444). A further example includes varying light rays output of the independent light source based on input provided via a user interface (block 447).

Some exemplary embodiments include activating an array of light emitting elements to facilitate determining a size or shape or perimeter parameter of the proximate retroreflective display (block 443). Another possible enhancement includes receiving at a communication module associated with the independent light source a modulated signal that includes informational data and/or a status request and/or a control command sent from the proximate retroreflective display (block 448).

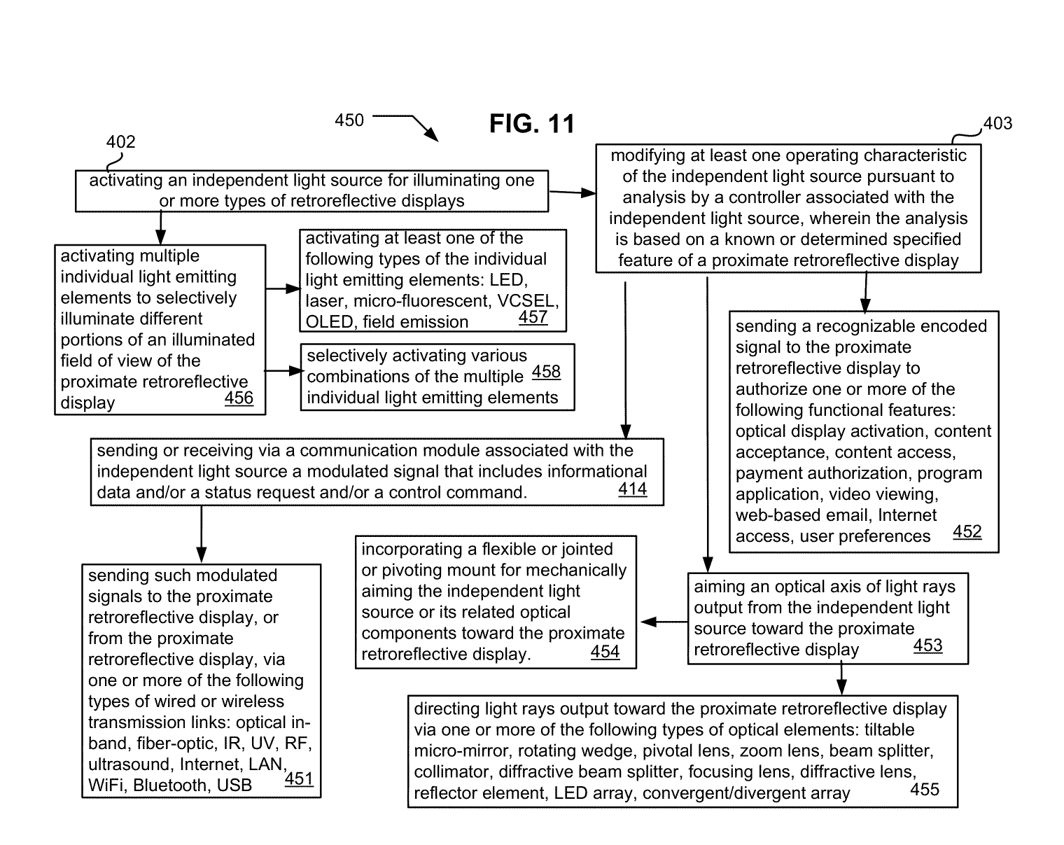

Referring to the flow chart of FIG. 11, various exemplary process features 450 are shown including previously described features 402, 403 which may be combined with sending or receiving via a communication module associated with the independent light source a modulated signal that includes informational data and/or a status request and/or a control command (block 414). Exemplary techniques for providing such modulated signals include sending such modulated signals to the proximate retroreflective display, or from the proximate retroreflective display, via one or more of the following types of wired or wireless transmission links: optical in-band, fiber-optic, IR, UV, RF, ultrasound, Internet, LAN, WiFi, Bluetooth, USB (block 451). Another possibility includes sending a recognizable encoded signal to the proximate retroreflective display to authorize one or more of the following functional features: optical display activation, content acceptance, content access, payment authorization, program application, video viewing, web-based email, Internet access, user preferences (block 452).

A further embodiment example includes aiming an optical axis of light rays output from the independent light source toward the proximate retroreflective display (block 453). A related aspect may include incorporating a flexible or jointed or pivoting mount for mechanically aiming the independent light source or its related optical components toward the proximate retroreflective display (block 454). In some instances an enhancement may include directing light rays output toward the proximate retroreflective display via one or more of the following types of optical elements: tiltable micro-mirror, rotating wedge, pivotal lens, zoom lens, rays splitter, collimator, diffractive rays splitter, focusing lens, diffractive lens, reflector element, LED array, convergent/divergent array (block 455).

As further illustrated in FIG. 11, some embodiments may provide an implementation that includes activating multiple individual light emitting elements to selectively illuminate different portions of an illuminated field of view of the proximate retroreflective display (block 456). Further possibilities include selectively activating various combinations of the multiple individual light emitting elements (block 458). Other examples include activating at least one of the following types of individual light emitting elements: LED, laser, micro-fluorescent, vertical cavity surface emitting laser (VCSEL), organic light emitting diode (OLED), field emission display (block 457).

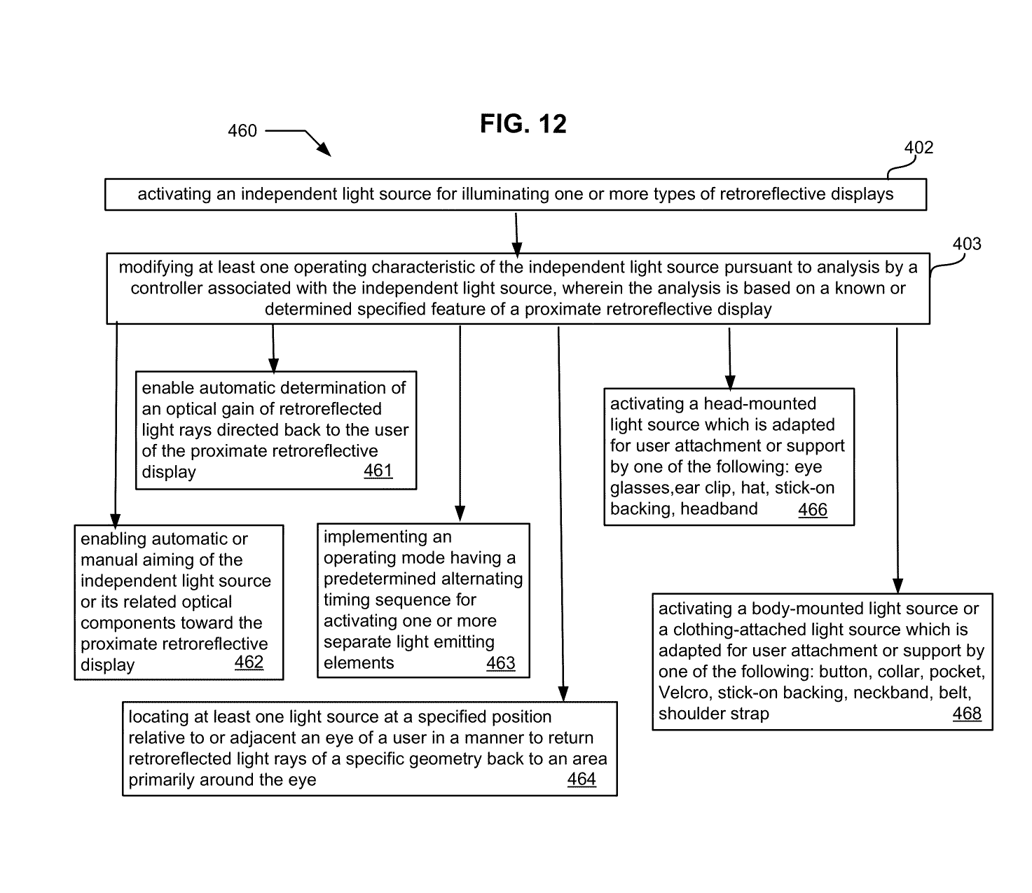

Various process features 460 depicted in the flow chart of FIG. 12 include previously described aspects 402, 403 in combination with enabling automatic or manual aiming of the independent light source or its related optical components toward the proximate retroreflective display (block 462). Other exemplary aspects enable automatic determination of an optical gain of retroreflected light rays directed back to the user of the proximate retroreflective display (block 461). A further example includes implementing an operating mode having a predetermined alternating timing sequence for activating one or more separate light emitting elements (block 463).

Some embodiments may include locating at least one independent light source at a specified position relative to or adjacent an eye of a user in a manner to return retroreflected light rays of a specific geometry back to an area primarily around the eye (block 464). Other possible process features include activating a head-mounted light source which is attachable or supportable by one of the following: eye glasses, ear clip, hat, stick-on backing, headband (block 466). Other possibilities include providing a body-mounted light source or a clothing-attached light source which is attachable or supportable by one of the following: button, collar, pocket, Velcro, stick-on backing, neckband, belt, shoulder strap (block 468).

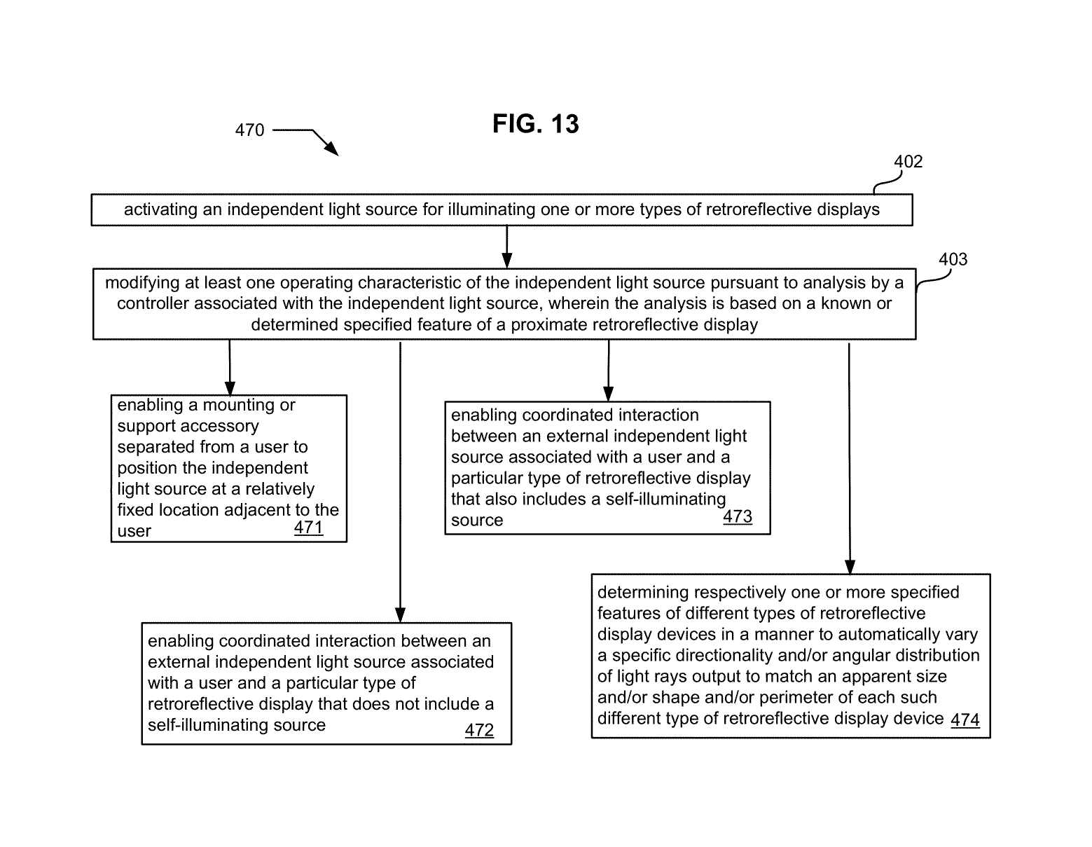

The detailed flow chart of FIG. 13 illustrates other embodiment features 470 including previously described process operations 402, 403 as well as in some instances enabling a mounting or support accessory separated from a user to position the independent light source at a relatively fixed location adjacent to the user (block 471). Another example includes enabling coordinated interaction between an external independent light source associated with a user and a particular type of retroreflective display that does not include a self-illumination source (block 472).

Additional process examples include enabling coordinated interaction between an external independent light source associated with a user and a particular type of retroreflective display that also includes a self-illumination source (block 473). In some instances a feature may include determining respectively one or more specified features of different types of retroreflective display devices in a manner to automatically vary a specific directionality and/or angular distribution of light rays output to match an apparent size and/or shape and/or perimeter of each such different type of retroreflective display device (block 474)

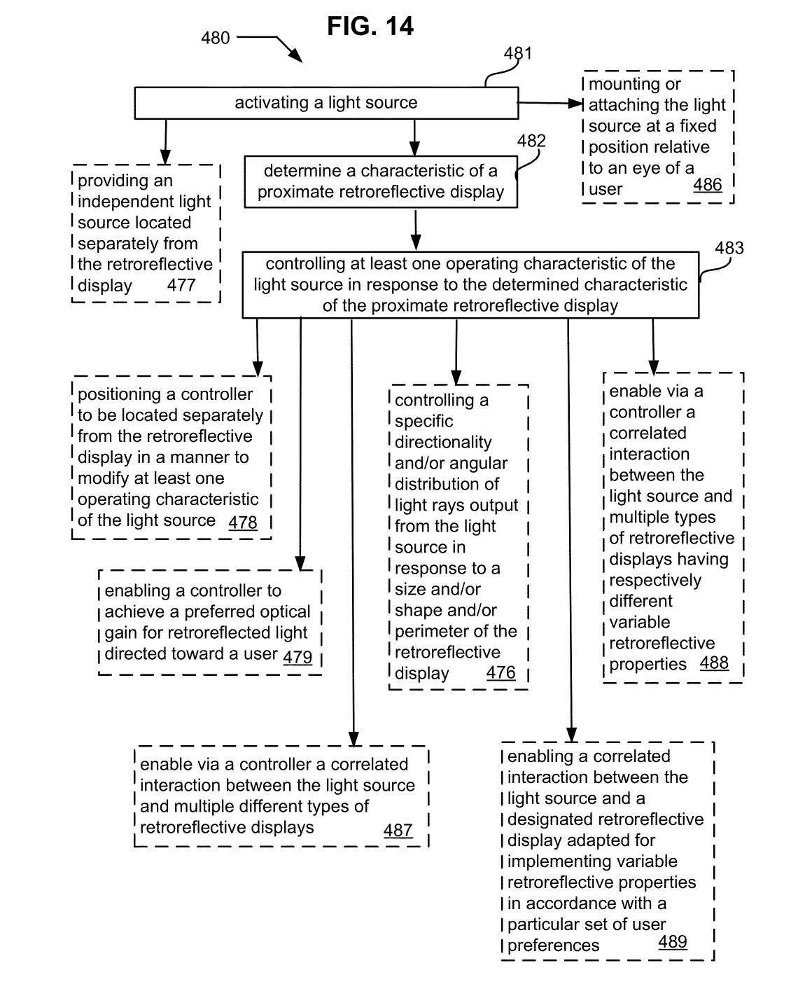

The higher level flow chart of FIG. 14 illustrates various exemplary features 480 for a retroreflective illumination method that includes activating a light source (block 481); determining a characteristic of a proximate retroreflective display (block 482), and controlling at least one operating characteristic of the light source in response to the determined characteristic of the proximate retroreflective display (block 483). Other possible process features include controlling a specific directionality and/or angular distribution of light rays output from the light source in response to a size and/or shape and/or perimeter of the retroreflective display (block 476).

Additional illustrated examples include providing an independent light source located separately from the retroreflective display (block 477), and positioning a controller to be located separately from the retroreflective display in a manner to modify at least one operating characteristic of the light source (block 478). Other possibilities include mounting or attaching the light source at a fixed position relative to an eye of a user (block 486), and enabling a controller to achieve a preferred optical gain for retroreflected light directed toward a user (block 479).

Some embodiments may enable via a controller a correlated interaction between the light source and multiple different types of retroreflective displays (block 487), or in some instances enable via a controller a correlated interaction between the light source and multiple types of retroreflective displays having respectively different variable retroreflective properties (block 488). A further possibility includes enabling a correlated interaction between the light source and a designated retroreflective display adapted for implementing variable retroreflective properties in accordance with a particular set of user preferences (block 489).

It will be understood from the exemplary embodiments disclosed herein that numerous individual method operations depicted in the flow charts of FIGS. 7-14 can be incorporated as encoded instructions in computer-readable media in order to obtain enhanced benefits and advantages.

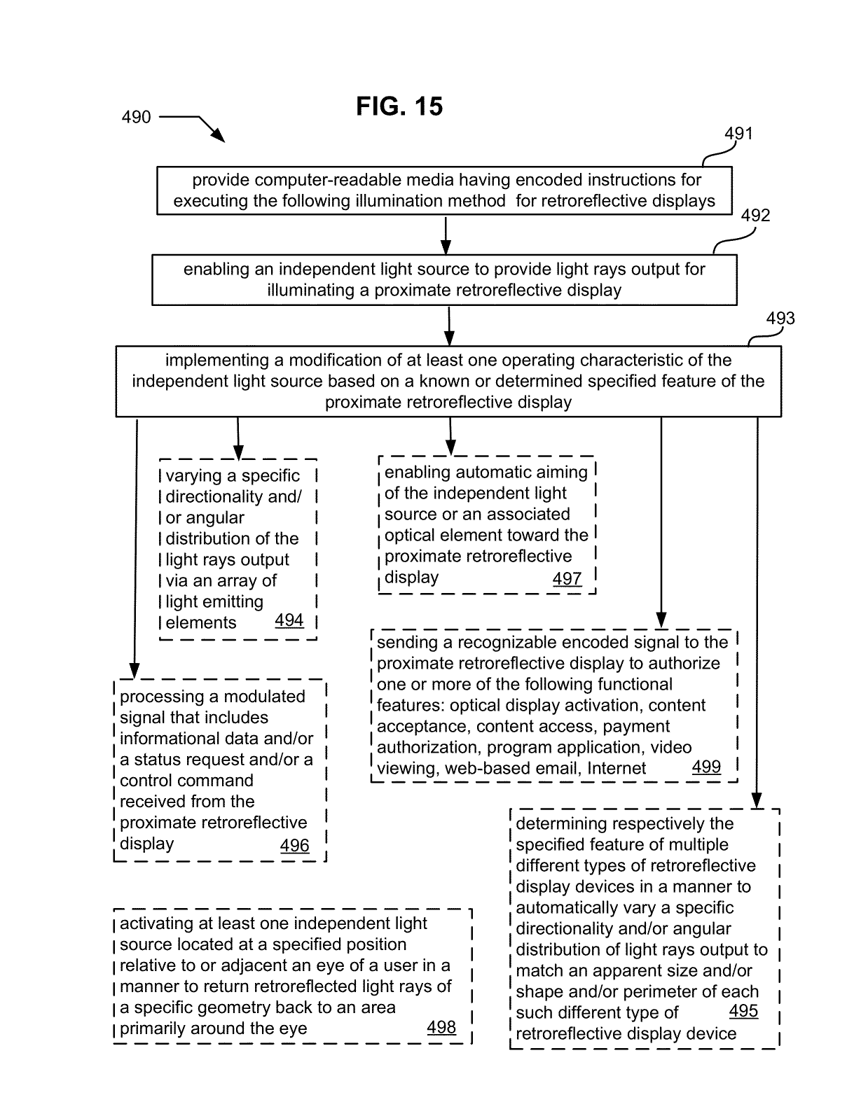

As another embodiment example, FIG. 15 shows a diagrammatic flow chart 490 depicting an article of manufacture which provides computer-readable media having encoded instructions for executing an illumination method for retroreflective displays (see block 491), wherein an exemplary method includes enabling an independent light source to provide light rays output for illuminating a proximate retroreflective display (block 492), and implementing a modification of at least one operating characteristic of the independent light source based on a known or determined specified feature of the proximate retroreflective display (block 493).

Additional programmed aspects may include varying a specific directionality and/or angular distribution of the light rays output via an array of light emitting elements (block 494). Another programmed method aspect may include processing a modulated signal that includes informational data and/or a status request and/or a control command received from the proximate retroreflective display (block 496). A further possible programmed method feature includes enabling automatic aiming of the independent light source or an associated optical element toward the proximate retroreflective display (block 497).

Other programmed method examples include activating at least one independent light source located at a specified position relative to or adjacent an eye of a user in a manner to return retroreflected light rays of a specific geometry back to an area primarily around the eye (block 498). In some instances a programmed aspect may include sending a recognizable encoded signal to the proximate retroreflective display to authorize one or more of the following functional features: optical display activation, content acceptance, content access, payment authorization, program application, video viewing, web-based email, Internet (block 499).

Other possible program embodiment features include determining respectively the specified feature of multiple different types of retroreflective display devices in a manner to automatically vary a specific directionality and/or angular distribution of light rays output to match an apparent size and/or shape and/or perimeter of each such different type of retroreflective display device (block 495).

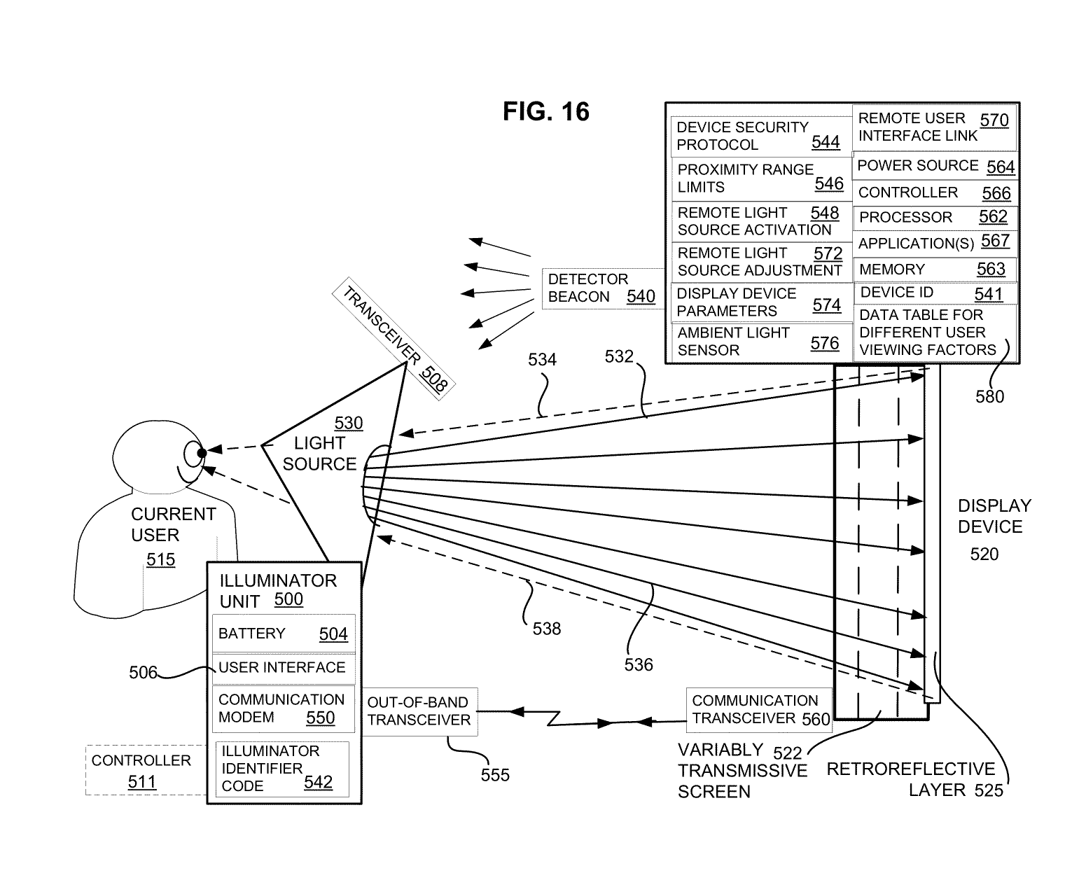

Referring to the schematic block diagram of FIG. 16, a further exemplary embodiment includes an enhanced retroreflective display device 520 having a variably transmissive screen 522 and a retroreflective layer 525. An illuminator unit 500 located separately from the display device provides light rays directed toward the retroreflective display device 520. More specifically an independent light source module 530 may be incorporated with the illuminator unit 500 and configured to direct collimated and/or divergent and/or convergent light rays toward the retroreflective layer 525.

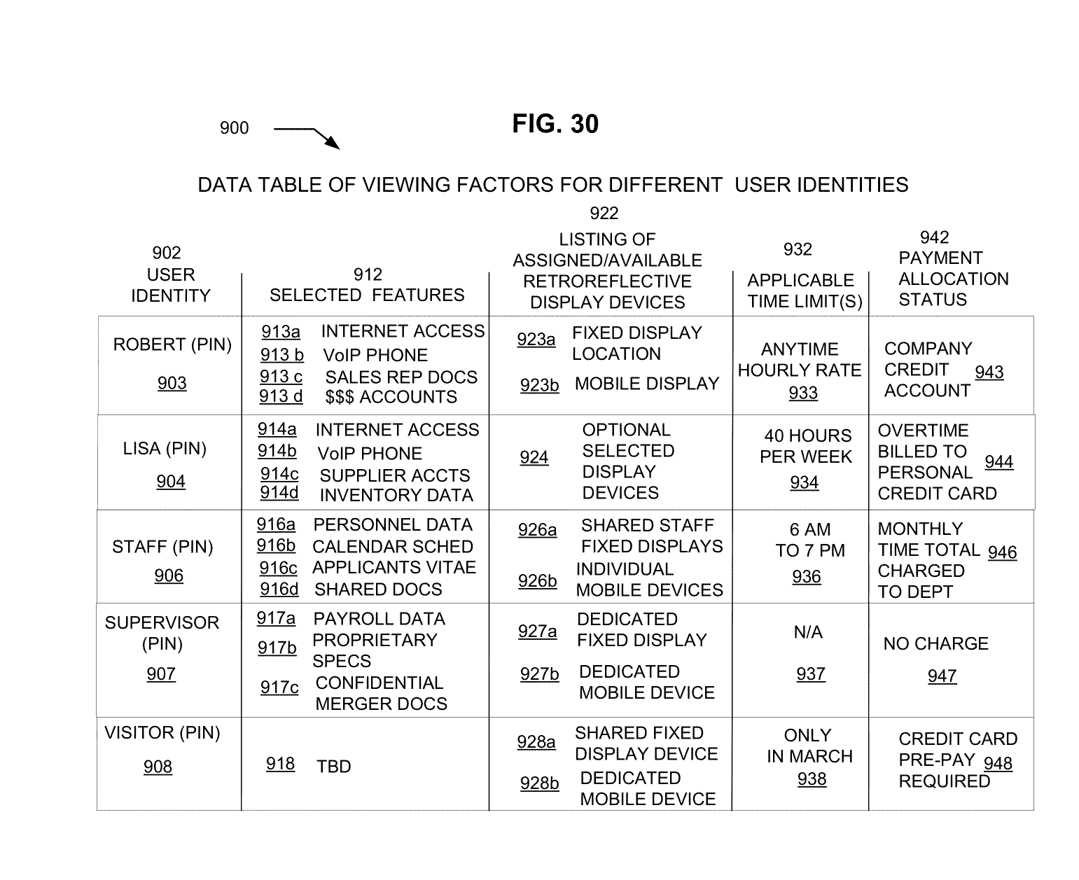

The display device 520 is adapted to include various operative components for controlling interaction with the illuminator unit 500 and its independent light source 530. In that regard, the exemplary display device 520 includes processor 562, memory 563, power source 564, controller 566, and one or more applications 567 to facilitate coordination between a fixed position (or in some instances movable) display device 520 and a mobile (or in some instances stationary) illumination unit 500. Additional data records and operational guidelines maintained with the display device 520 relate to proximity range limits 546, remote independent light source activation 548, remote independent light source adjustment 572, and display device parameters 574. Also included with exemplary display device 520 is an ambient light sensor 576 and a data table of viewing factors 580 applicable to different users (see FIG. 30).

Some retroreflective system embodiments may be configured to provide capability for activating features of the display device 520 pursuant to a device security protocol 544 which is based on confirmation via controller 566 of a device identifier 541 and a corresponding illuminator identifier code 542. Such features may include appropriate combinations of allowing or enabling or disenabling certain operational features of the display device 520 in accordance with predetermined guidelines associated with a particular user or group of users, or in some instances based on a type of light source that is included with the illuminator unit.

In some embodiments a current user 515 may have access to the display device components via a remote user interface link 570 for the display device 520. In that regard the display device 520 may include a communication transceiver 560 adapted for bidirectional signal transmission with an out-of-band transceiver 555 linked to a communication modem 550 incorporated with the illuminator unit 500. Of course other alternative or supplemental wireless signal transmission links (e.g., see detector beacon 540, transceiver 508) may be provided to achieve coordinated interaction with the display device 520 as well as controlling optimal adjustment of light rays sent from the illuminator unit 500. The illuminator unit 500 may include processor 502, power source 504, and a user interface 506 associated with a current user 515. In some instances alternative or supplemental data processing may also be provided by controller 511 incorporated with the illuminator unit 500.

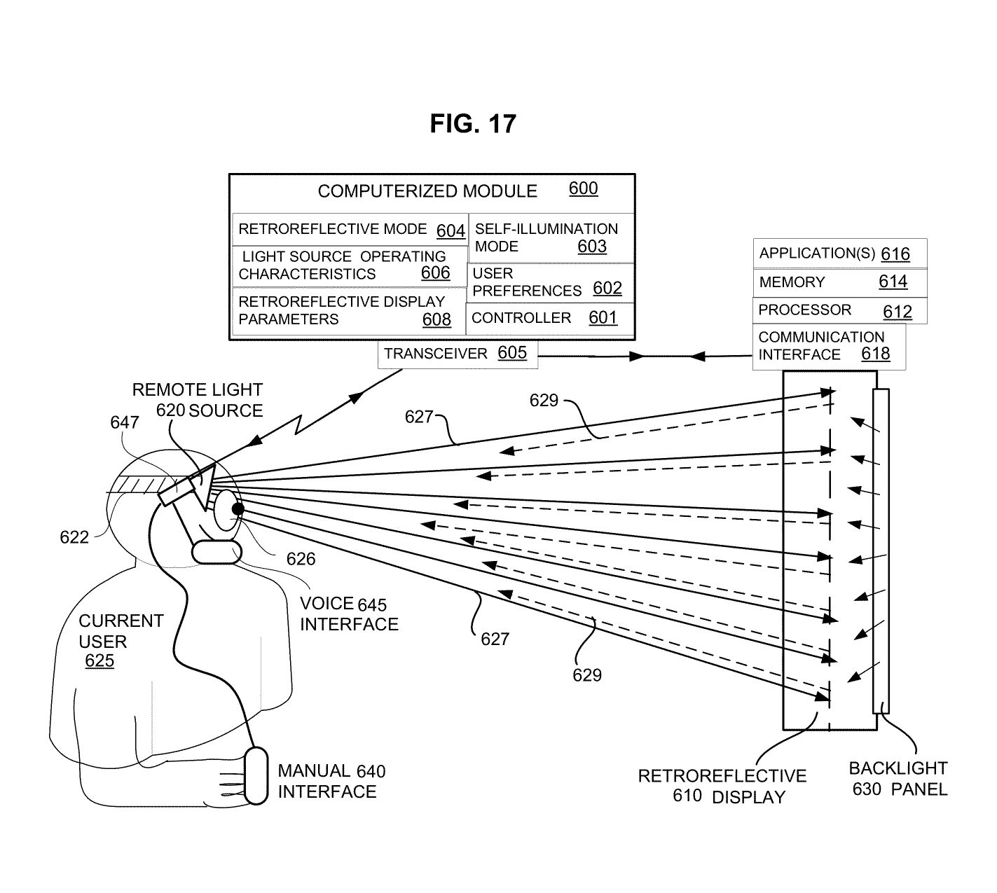

Referring to the higher level schematic block diagram of FIG. 17, an exemplary retroreflective system embodiment includes a computerized module 600 configured for implementing interactive coordination between a retroreflective display 610 and a remote light source 620 mounted (e.g., see headband 622) adjacent an eye 626 of a current user 625. In that regard the illustrated computerized module 600 includes transceiver 605 connected via wired or wireless link with an illumination unit 647 for the remote light source 620, and also connected via wired or wireless link with a communication interface 618 for the retroreflective display 610. The light rays output 627 are directed toward the retroreflective display 610 in a manner to cause retroreflected light rays 629 to be sent back in a geometric distribution pattern toward the eye 626 of the current user 625.

The computerized module 600 may be incorporated with the retroreflective display 610, or in some instances incorporated with the remote light source 620, or in other instances located separate and apart from both the retroreflective display 610 and the remote light source 620. User interaction and user inputs may be accomplished with a manual interface 640 shown having a wired connection to the illumination unit 647. Some implementations may enable different types of user interaction such as with a voice interface 645 and/or with an aural interface (not shown) which have direct or indirect communication links to the illumination unit 647 and to transceiver 605 and to communication interface 618.

It will be understood that the various communication interconnections and controller functions may be incorporated in many different combinations and implementations (e.g., see processor 612, memory 614, applications 616 incorporated with retroreflective display 610), and the examples given are not intended to be limiting and may be altered depending on the circumstances.

The illustrated controller module 600 includes controller 601 along with other computerized components (not shown) in order to obtain and process retroreflective display parameters 608 as a basis for adjusting certain light source operating characteristics 606 of the remote light source 620 in accordance with user preferences 602. It will be understood that such correlation between the remote light source 620 and the retroreflective display 610 will provide improved brightness and/or contrast for the current user 625 during a retroreflective operational mode 604.

In some embodiments a retroreflective illumination system may operate in conjunction with a display having a self-illuminating mode 603 (e.g., backlight panel 630, light emissive elements, etc.). As shown in the exemplary embodiment of FIG. 17, the controller 601 may determine the illuminator operating mode characteristics based on conservation of battery life or enhancement of viewing clarity during darkened scattered light conditions. In some instances the controller 601 may dictate exclusive activation of the retroreflective illumination mode during a particular time period or alternatively dictate exclusive activation of the self-illuminating mode during another time period, depending on ambient light conditions (e.g., screen washout) and/or battery life status.

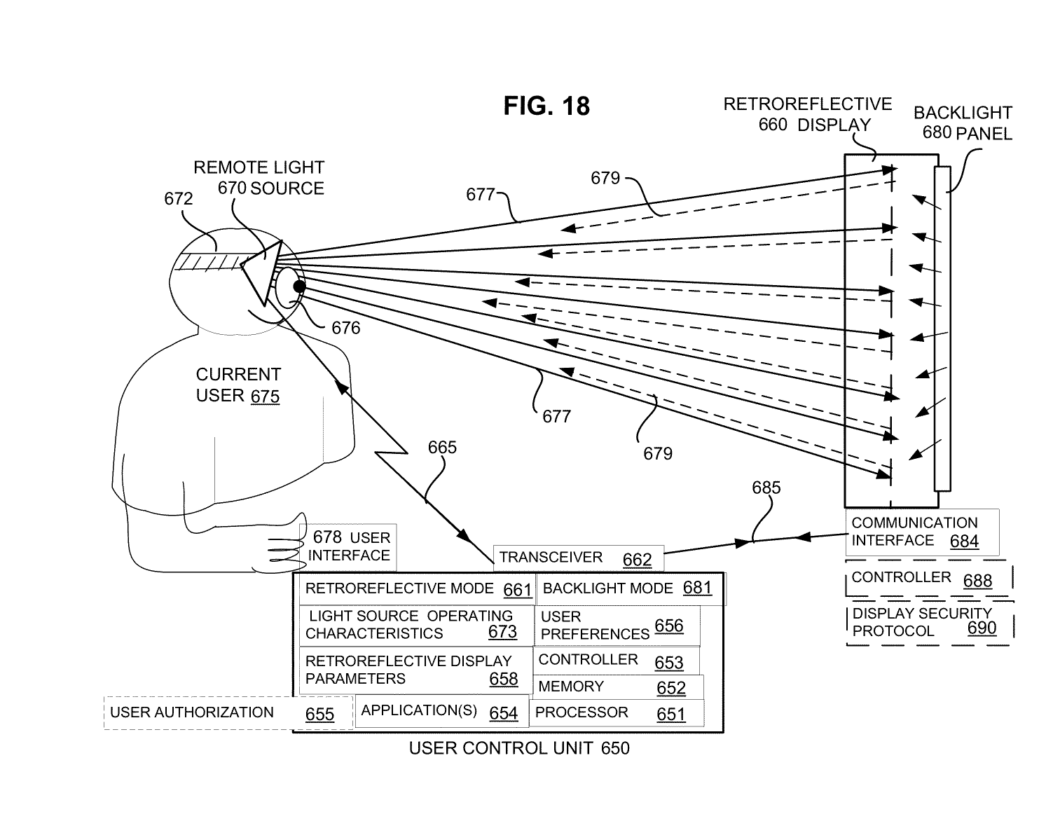

Referring to the schematic block diagram of FIG. 18, an exemplary retroreflective display system for a current user 657 includes a remote light source 670 mounted adjacent (see headband 762) a user's eye 676 for transmitting light rays output 677 toward a proximate retroreflective display 660. The remote light source may be associated with user control unit 650 having a transceiver 662 for implementing a modification of certain operating characteristics 673 of the remote light source 670 pursuant to signal transmissions via a communication channel (e.g., wireless link 665). Such signal transmissions may include informational data and/or a status request and/or a control command which are based on known or determined retroreflective display parameters 658 of the proximate retroreflective display 660.

The illustrated user control unit 650 includes processor 651, memory 652, controller 653, and one or more applications 654 in order to process such known or determined retroreflective display parameters 658 as a basis for achieving improved brightness and/or contrast for the current user 675 during a retroreflective operational mode 661. The user control unit 650 may also be adapted for sending or receiving signal transmissions via wireless link 685 to a communication interface 684 of the retroreflective display 660.

Some retroreflective displays 660 may include a controller 688 and related computerized components for processing signal transmissions that include informational data and/or a status request and/or a control command regarding adjustment of operational characteristics of the remote light source 670 during a retroreflective operational mode 661. In some instances a backlight panel 680 may be incorporated with the retroreflective display 660 in order to enable a self-illumination (e.g., backlight mode 681) as an alternative or supplemental illumination technique.

Further optional aspects disclosed in the exemplary embodiment features of FIG. 18 include a security protocol 690 associated with the retroreflective display 660 for confirming an approved user authorization 655 in connection with initial activation of a retroreflective operational mode. Other functional aspects of the retroreflective display 660 which might be subject to such security protocol 690 include content acceptance, content access, payment authorization, program applications, video viewing, web-based email, Internet access, and user preferences.

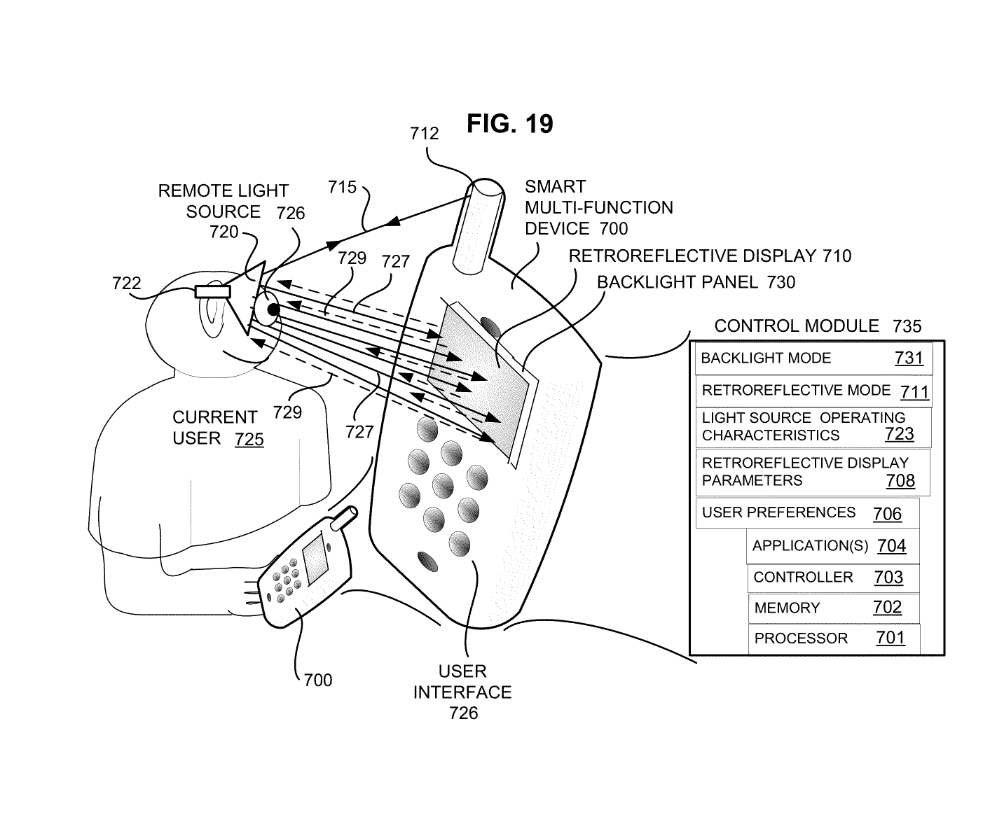

As shown in the illustrated embodiments of the schematic block diagram of FIG. 19, a mobile hand-held unit such as smart multi-function device 700 may be configured for retroreflective illumination by remote light source 720 positioned adjacent to a current user 725 of the smart multi-function device 700. The remote light source may be mounted on a body portion (e.g., head) of the current user 725 by an attachment such as ear clip 722. In that regard the light rays output 727 are directed toward a retroreflective display 710 of the smart multi-function device 700 in a manner to cause the retroreflected light rays 729 to be sent back in a geometric distribution pattern back toward an eye 726 of the current user 725.

The exemplary smart multi-function device 700 includes a control module 735, user interface 728 and antenna 712 for implementing a modification of certain operating characteristics of the remote light source 720 pursuant to signal transmissions via wireless link 715. Such signal transmissions may include informational data and/or a status request and/or a control command. The illustrated control module 735 includes processor 701, memory 702, controller 703, and one or more applications 704 in order to process known or determined retroreflective display parameters as a basis for correlation with the remote light source 735 to achieve improved clarity and increased optical gain for the current user 725 during a retroreflective operational mode 711. Some embodiments may include a backlight panel 730 that enables a backlight operational mode 731 as an alternative illumination technique for the retroreflective display 710.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs.

Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

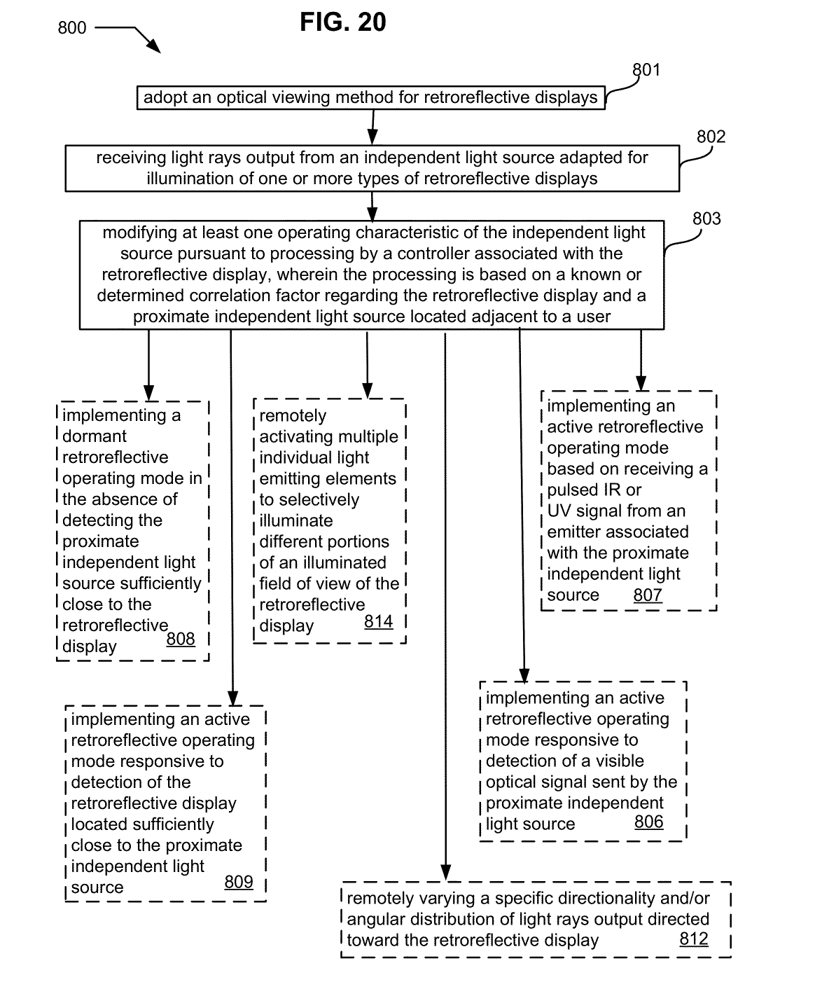

The high level flow chart of FIG. 20 depicts various process aspects 800 regarding adoption of an optical viewing method for retroreflective displays (see block 801), wherein the method may include receiving light rays output from an independent light source adapted for illumination of one or more types of retroreflective displays (block 802), as well as modifying at least one operating characteristic of the independent light source pursuant to processing by a controller associated with the retroreflective display, wherein the processing is based on a known or determined correlation factor regarding the retroreflective display and a proximate independent light source located adjacent to a user (block 803).

Another method example includes implementing an active retroreflective operating mode responsive to detection of a visible optical signal sent by the proximate independent light source (block 806). Further examples include implementing an active retroreflective operating mode based on receiving a pulsed IR or UV signal from an emitter associated with the proximate independent light source (block 807). A related possible aspect includes implementing a dormant retroreflective operating mode in the absence of detecting the proximate independent light source sufficiently close to the retroreflective display (block 808). Another related possible aspect includes implementing an active retroreflective operating mode responsive to detection of the retroreflective display located sufficiently close to the proximate independent light source (block 809).

Also shown in FIG. 20 are further method examples that include remotely varying a specific directionality and/or angular distribution of light rays output directed toward the retroreflective display (block 812). Another example includes remotely activating multiple individual light emitting elements to selectively illuminate different portions of an illuminated field of view of the retroreflective display (block 814).

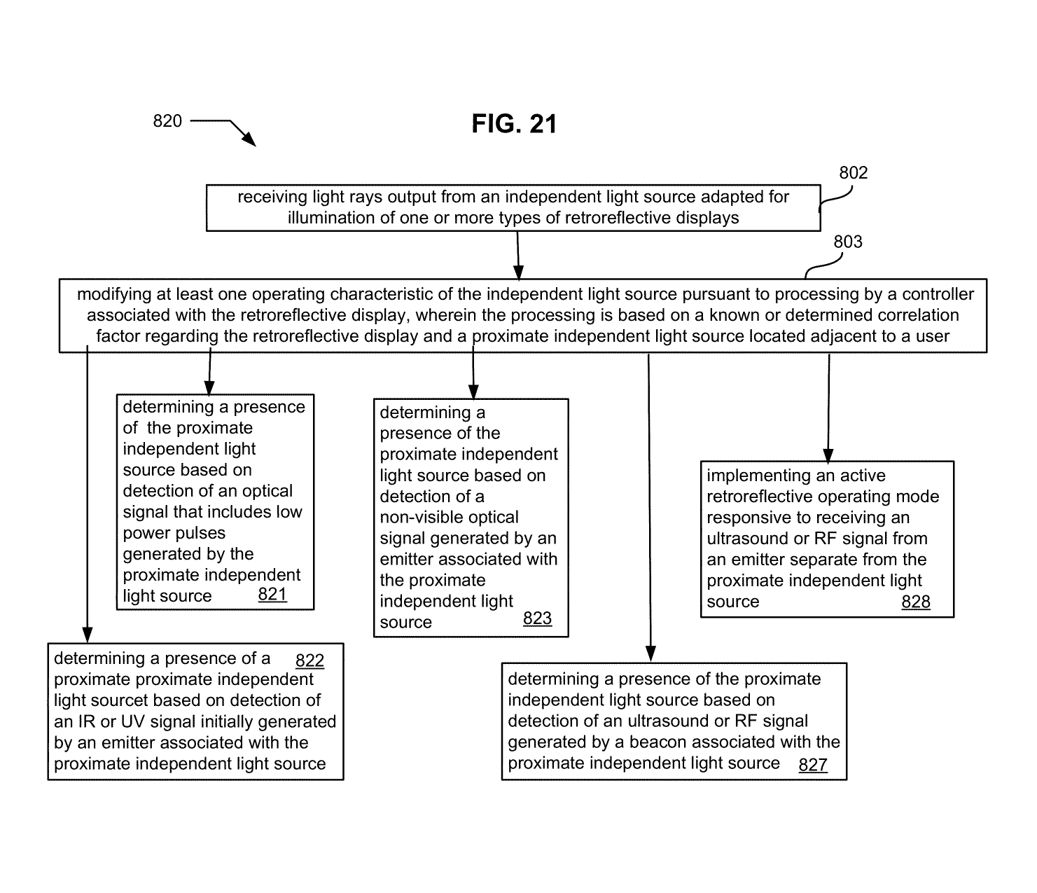

Referring to the embodiment features 820 shown in the detailed flow chart of FIG. 21, possible method aspects include previously described operations 802, 803 in combination with various proximity detection techniques. For example, a possible aspect includes determining a presence of a proximate independent light source based on detection of an optical signal that includes low power pulses generated by the proximate independent light source (block 821). A further example includes determining a presence of a proximate independent light source based on detection of an IR or UV signal initially generated by an emitter associated with the independent light source (block 822).

Other implementations may include determining a presence of a proximate independent light source based on detection of a non-visible optical signal by an emitter associated with the proximate independent light source (block 823). Another possibility includes determining a presence of the proximate independent light source based on detection of an ultrasound or RF signal generated by a beacon associated with the proximate independent light source (block 827). Further aspects may include implementing an active retroreflective operating mode responsive to receiving an ultrasound or RF signal from an emitter separate from the proximate independent light source (block 828).

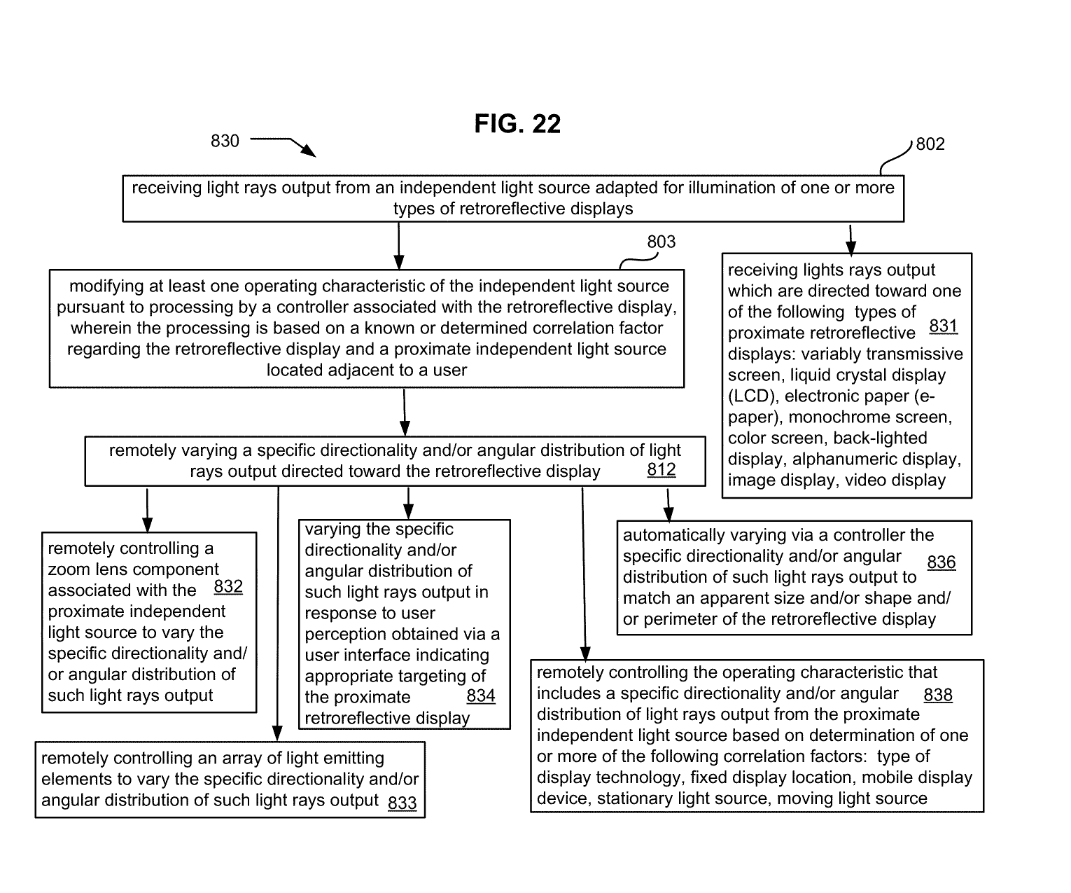

The detailed flow chart of FIG. 22 shows exemplary process features 830 that include previously described aspects 802, 803 in combination with remotely varying a specific directionality and/or angular distribution of light rays output directed toward the retroreflective display (block 812). Related aspects may include remotely controlling a zoom lens component associated with the proximate independent light source to vary the specific directionality and/or angular distribution of the light rays output (block 832), or in some instances remotely controlling an array of light emitting elements to vary the particular directionality and/or angular distribution of such light rays output (block 833). A further related aspect may include varying the specific directionality and/or angular distribution of the light rays output via a user interface indicating appropriate targeting of the proximate retroreflective display (block 834).

Additional possibilities include automatically varying via a controller the specific directionality and/or angular distribution of such light rays output to match an apparent size and/or shape and/or perimeter of the retroreflective display (block 836). Some embodiments may include remotely controlling the operating characteristic that includes a specific directionality and/or angular distribution of light rays output from the proximate independent light source based on determination of one or more of the following correlation factors: type of display technology, fixed display location, mobile display device, stationary light source, moving light source (block 838).

Further aspects may include receiving lights rays output which are directed toward one of the following types of proximate retroreflective displays: variably transmissive screen, liquid crystal display (LCD), electronic paper (e-paper), monochrome screen, color screen, back-lighted display, alphanumeric display, image display, video display (block 831).

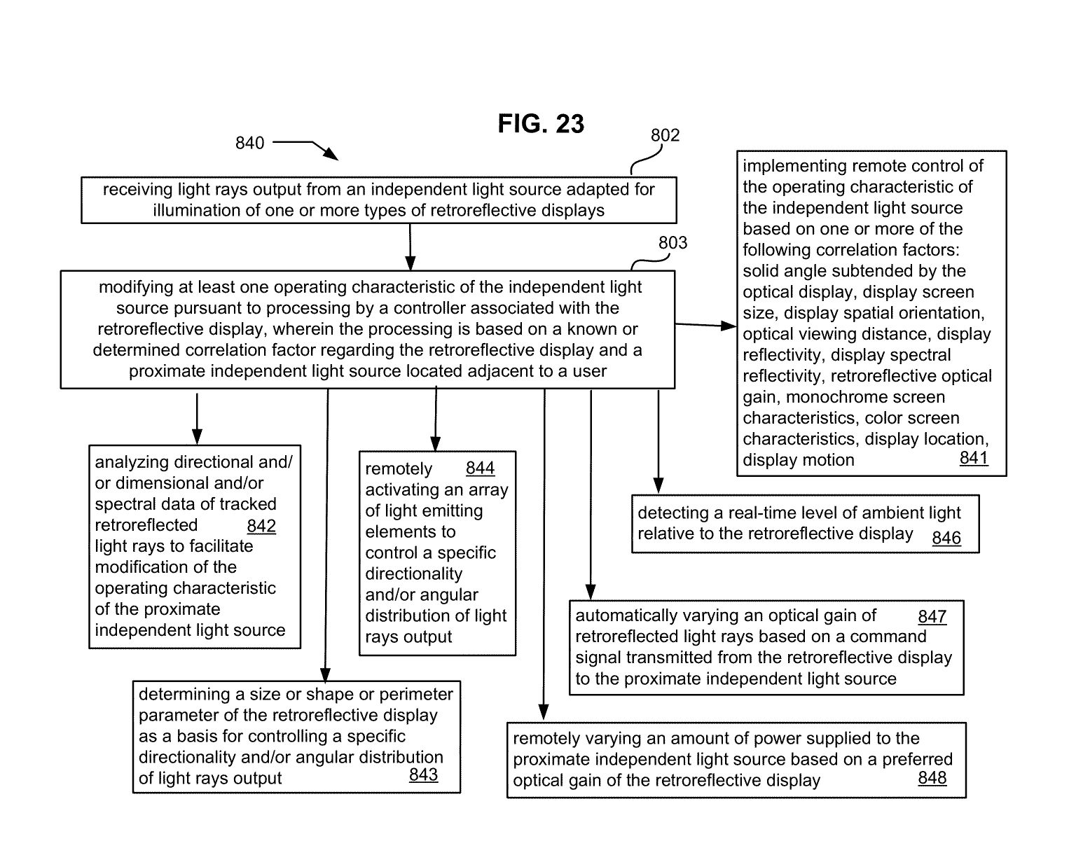

Referring to the detailed flow chart of FIG. 23, possible process aspects 840 are illustrated including previously described operations 802, 803 along with implementing remote control of the operating characteristic of the independent light source based on one or more of the following correlation factors: solid angle subtended by the optical display, display screen size, display spatial orientation, optical viewing distance, display retroreflectivity, display directional reflectivity, display spectral reflectivity, retroreflective optical gain, monochrome screen characteristics, color screen characteristics, display location, display motion (block 841). A related aspect may include analyzing directional and/or dimensional and/or spectral data of tracked retroreflected light rays to facilitate modification of the operating characteristic of the proximate independent light source (block 842).

Another process example includes determining a size or shape or perimeter parameter of the retroreflective display as a basis for controlling a specific directionality and/or angular distribution of light rays output (block 843). An additional feature may include remotely activating an array of light emitting elements to control a specific directionality and/or angular distribution of light rays output (block 844).

Further process possibilities include detecting a real-time level of ambient light relative to the retroreflective display (block 846). In some instances an embodiment may include automatically varying an optical gain of retroreflected light rays based on a command signal transmitted from the retroreflective display to the proximate independent light source (block 847). Another possible feature includes remotely varying an amount of power supplied to the proximate independent light source based on a preferred optical gain of the retroreflective display (block 848).

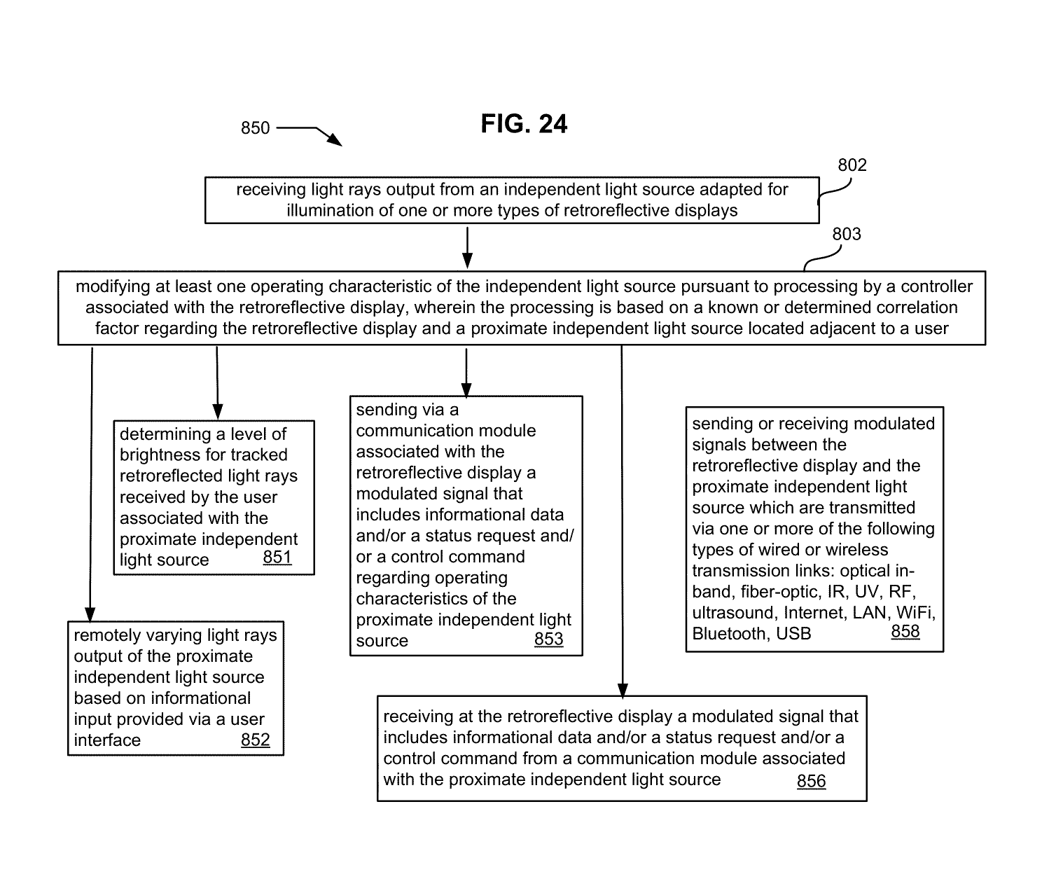

The flow chart of FIG. 24 illustrates exemplary embodiment features 850 that include previously described aspects 802, 803 in combination with determining a level of brightness for tracked retroreflected light rays received by the user associated with the proximate independent light source (block 851). Another aspect may include remotely varying light rays output of the proximate independent light source based on informational input provided via a user interface (block 852). Additional possibilities include sending via a communication module associated with the retroreflective display a modulated signal that includes informational data and/or a status request and/or a control command regarding operating characteristics of the proximate independent light source (block 853).

In some instances an embodiment may include receiving at the retroreflective display a modulated signal that includes informational data and/or a status request and/or a control command from a communication module associated with the proximate independent light source (block 856). A further example includes sending or receiving modulated signals between the retroreflective display and the proximate independent light source which are transmitted via one or more of the following types of wired or wireless transmission links: optical in-band, fiber-optic, IR, UV, RF, ultrasound, Internet, LAN, WiFi, Bluetooth, USB (block 858).

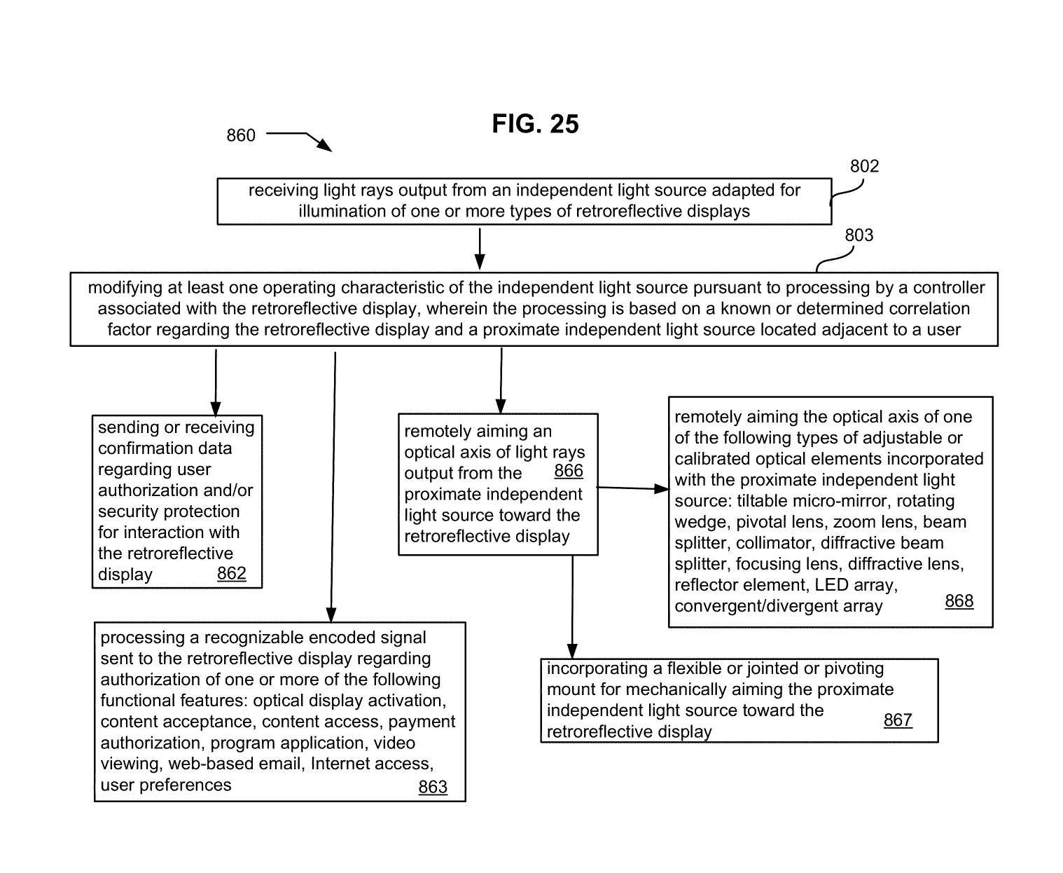

Various exemplary embodiment features 860 shown in the detailed flow chart of FIG. 25 include previously described aspects 802, 803 in combination with sending or receiving confirmation data regarding user authorization and/or security protection for interaction with the retroreflective display (block 862). Other method enhancements may include processing a recognizable encoded signal sent to the retroreflective display regarding authorization of one or more of the following functional features: optical display activation, content acceptance, content access, payment authorization, program application, video viewing, web-based email, Internet access, user preferences (block 863).

A further possible feature includes remotely aiming an optical axis of light rays output from the proximate independent light source toward the retroreflective display (block 866). A related example includes incorporating a flexible or jointed or pivoting mount for mechanically aiming the proximate independent light source toward the retroreflective display (block 867). In some instances an exemplary embodiment includes remotely aiming the optical axis of one of the following types of adjustable or calibrated optical elements incorporated with the proximate independent light source: tiltable micro-mirror, rotating wedge, pivotal lens, zoom lens, beam splitter, collimator, diffractive beam splitter, focusing lens, diffractive lens, reflector element, LED array, convergent/divergent array (block 868).

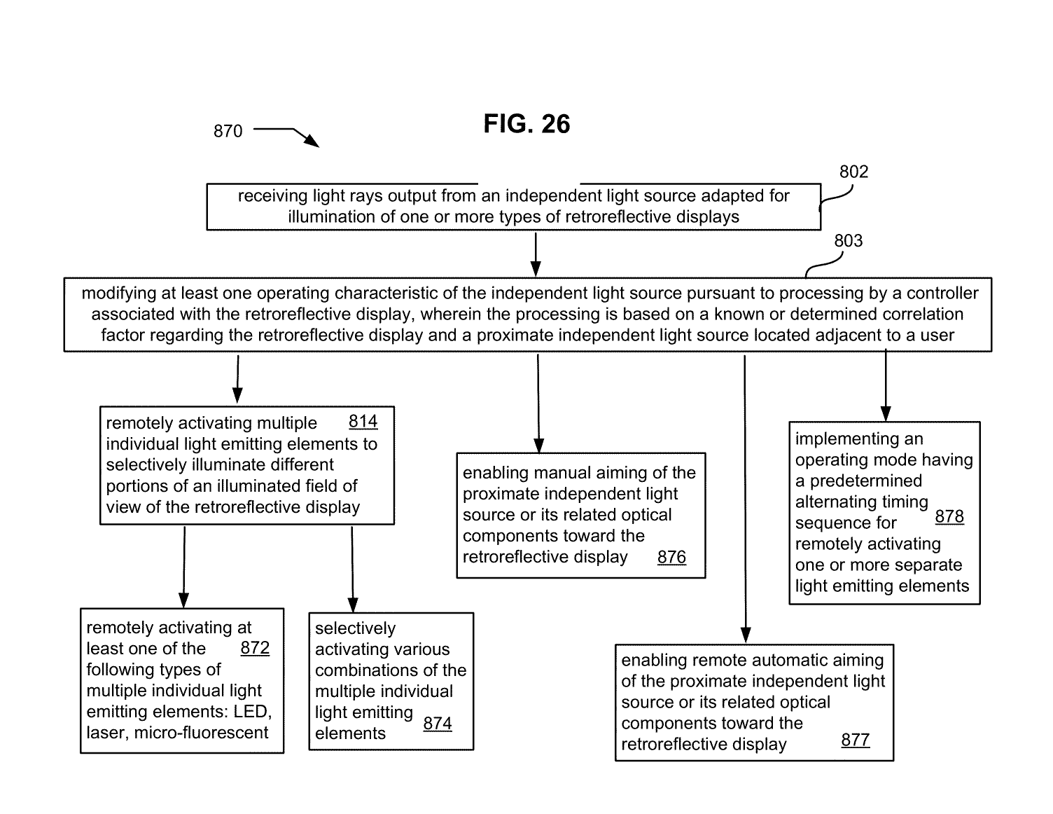

The embodiment features 870 illustrated in the detailed flow chart of FIG. 26 include previously described operations 802, 803 along with remotely activating multiple individual light emitting elements to selectively illuminate different portions of an illuminated field of view of the retroreflective display (block 814). Related aspects may include remotely activating at least one of the following types of multiple individual light emitting elements: LED, laser, micro-fluorescent (block 872). Further related aspects may include activating various combinations of the multiple individual light-emitting elements (block 874).

In some instances an embodiment includes enabling manual aiming of the proximate independent light source or its related optical components toward the retroreflective display (block 876). A related example includes enabling remote automatic aiming of the proximate independent light source or its related optical components toward the retroreflective display (block 877). Some embodiments may include implementing an operating mode having a predetermined alternating timing sequence for remotely activating one or more separate light emitting elements (block 878).

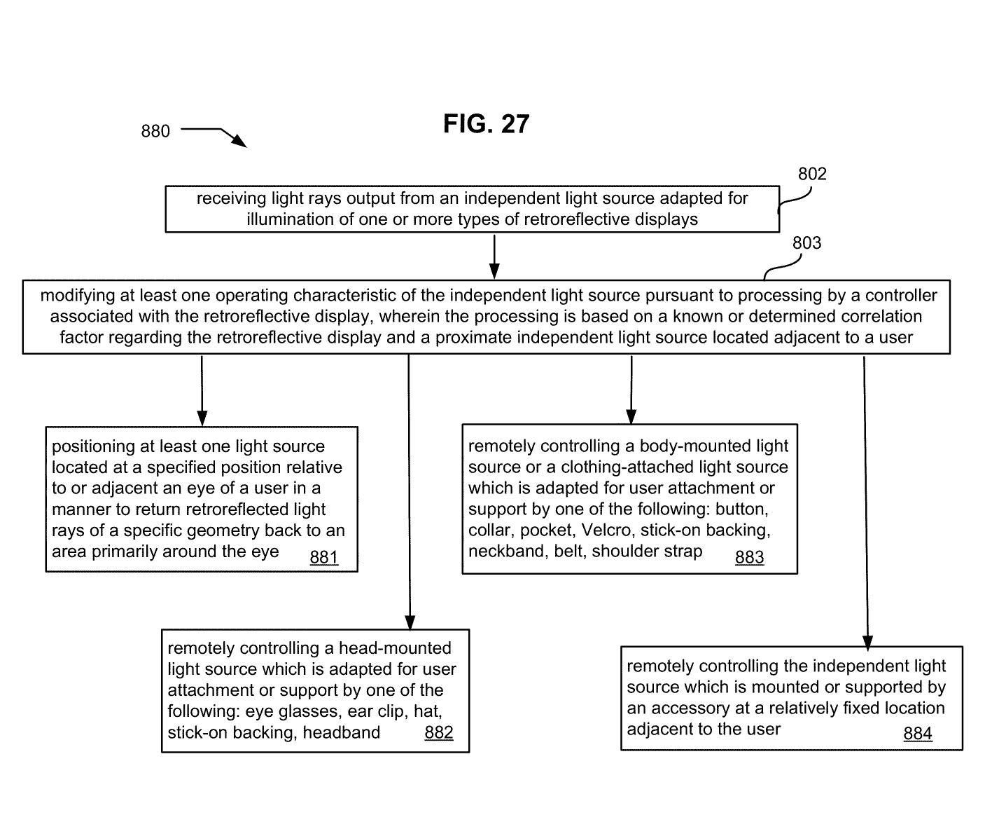

The detailed flow chart of FIG. 27 illustrates exemplary features 880 that include previously described operations 802, 803 as well as positioning at least one light source located at a specified position relative to or adjacent an eye of a user in a manner to return retroreflected light rays of a specific geometry back to an area primarily around the eye (block 881). A further aspect may include remotely controlling a head-mounted light source which is adapted for user attachment or support by one of the following: eye glasses, ear clip, hat, stick-on backing, headband (block 882).

Some examples include remotely controlling a body-mounted light source or a clothing-attached light source which is adapted for user attachment or support by one of the following: button, collar, pocket, Velcro, stick-on backing, neckband, belt, shoulder strap (block 883). Further possibilities include remotely controlling the independent light source which is mounted or supported by an accessory at a relatively fixed location adjacent to the user (block 884).

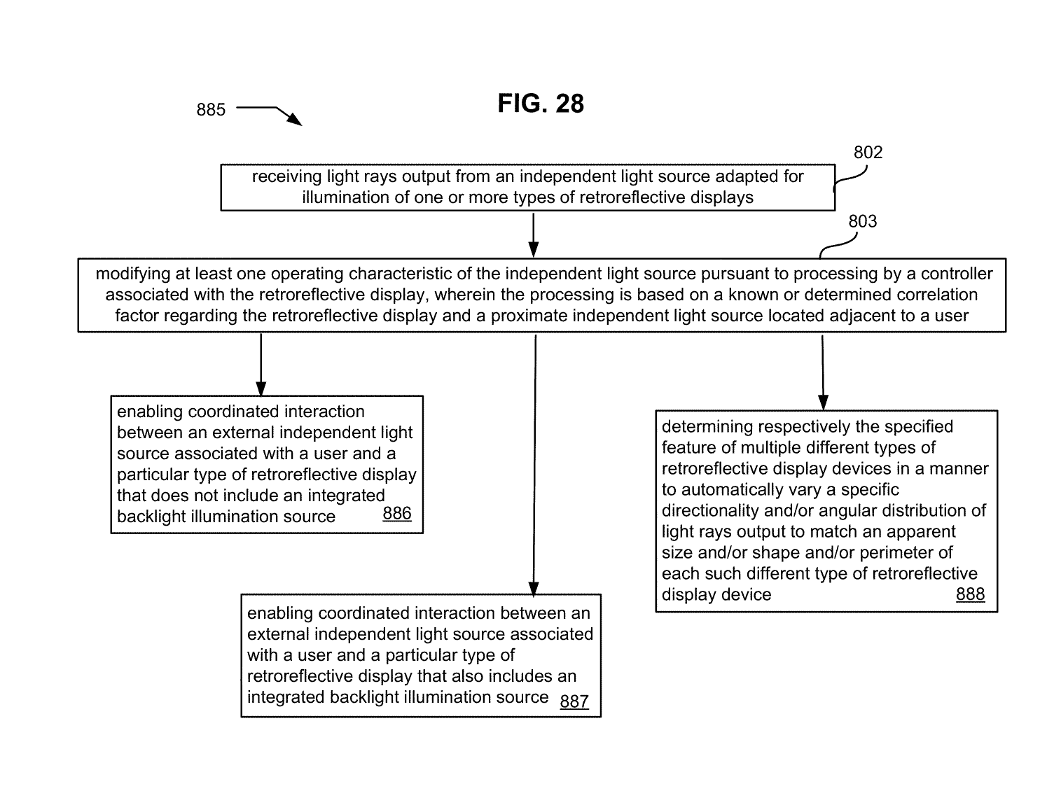

Referring to the exemplary features 885 illustrated in the detailed flow chart of FIG. 28, possible process operations include previously described aspects 802, 803 in combination with enabling coordinated interaction between an external independent light source associated with a user and a particular type of retroreflective display that does not include an integrated backlight illumination source (block 886). Other embodiments may include enabling coordinated interaction between an external independent light source associated with a user and a particular type of retroreflective display that also includes an integrated backlight illumination source (block 887).

Another example may include determining respectively the specified feature of multiple different types of retroreflective display devices in a manner to automatically vary a specific directionality and/or angular distribution of light rays output to match an apparent size and/or shape and/or perimeter of each such different type of retroreflective display device (block 888).

It will be understood from the exemplary embodiments disclosed herein that numerous individual method operations shown in the flow charts of FIGS. 20-28 can be incorporated as encoded instructions in computer-readable media in order to obtain enhanced benefits and advantages.

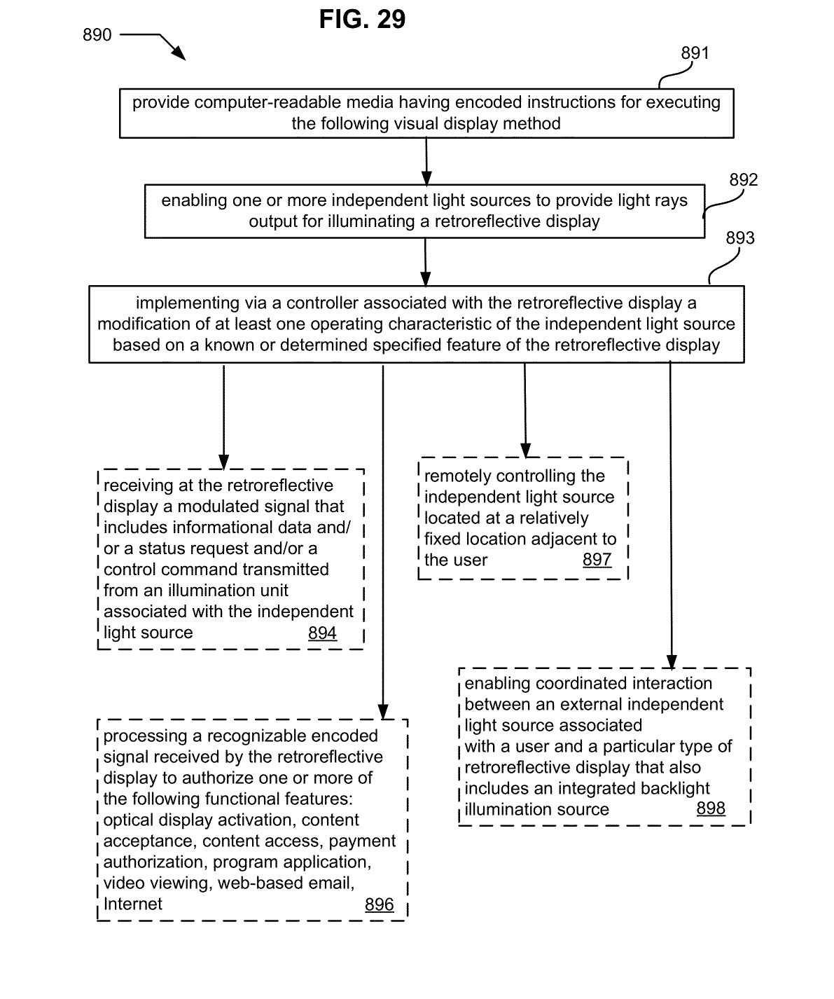

As another embodiment example, FIG. 29 shows a diagrammatic flow chart 890 depicting an article of manufacture which provides computer-readable media having encoded instructions for executing a visual display method (see block 891), wherein an exemplary method includes enabling one or more independent light sources to provide light rays output for illuminating a retroreflective display (block 892), and implementing via a controller associated with the retroreflective display a modification of at least one operating characteristic of the independent light source based on a known or determined specified feature of the retroreflective display (block 893).

Additional examples of programmed features include receiving at the retroreflective display a modulated signal that includes informational data and/or a status request and/or a control command transmitted from an illumination unit associated with the independent light source (block 894). Some computer programmed embodiments may include processing a recognizable encoded signal received by the retroreflective display to authorize one or more of the following functional features: optical display activation, content acceptance, content access, payment authorization, program application, video viewing, web-based email, Internet (block 896).

Another programmed feature example includes remotely controlling the independent light source located at a relatively fixed location adjacent to the user (block 897). Another possible programmed aspect includes enabling coordinated interaction between an external independent light source associated with a user and a particular type of retroreflective display that also includes an integrated backlight illumination source (block 898).

The exemplary data table of FIG. 30 illustrates an exemplary data table 900 for different viewing factors applicable to an identified individual or group user of one or more types of retroreflective display devices. Referring to a representative set of exemplary illustrated user preferences, various categories of display screen viewing factors may be programmed to be predetermined or optionally selected for each user identity 902. Such categories may include selected features 912, a listing of assigned or available retroreflective display devices 922, applicable time limit(s) 932, and payment allocation status 942.

For example, a user identity that includes a personal identification number (PIN) such as “Robert (PIN)” 903 could be associated with certain selected features 912 that may include Internet access 913a, VoIP phone 913b, sales rep documents 913c, and various financial accounts 913d (e.g., accounts receivable, accounts payable, etc.). Further associated aspects might indicate assigned or available retroreflective devices 922 such as a fixed display location 923a and a mobile display 923b correlated with an applicable time period 932 (e.g., an “anytime hourly rate” 933). An associated payment allocation status 942 could in some instances indicate a “company credit account” 943.

As another example, a user identity such as “Lisa (PIN)” 904 could be associated with certain selected features 912 that may include Internet access 914a, VoIP phone 914b, supplier accounts 914c and inventory data 914d. Other associated aspects might indicate assigned or available retroreflective devices 922 such as optional selected display devices 942 correlated with an applicable time limit of “40 hours per week” 934. An associated payment allocation status 942 may indicate “overtime billed to personal credit card” 944.

A further example might include a member of the collective user group name “Staff (PIN)” associated with certain selected features 912 that may include personnel data 916a, calendar schedule 916b, applicants vitae 916c and shared documents 916d. Other associated aspects could in some instances indicate assigned or available retroreflective devices 922 such as shared staff fixed displays 926a and individual mobile devices 926 correlated with an applicable time limit of “6 AM to 7 PM” 936. An associated payment allocation status 932 may indicate “monthly time total charged to department” 946.

An additional illustrated example for a user identity of “supervisor (PIN)” 907 may be associated with certain selected features 912 that may include payroll data 917a, proprietary specifications 917b and confidential merger documents 917c. Other associated aspect might include assigned or available retroreflective devices 922 such as dedicated fixed display 927a and dedicated mobile device 927b correlated with an absence of any time limit “N/A” 937. An associated payment allocation status 932 may indicated “no charge” 947.

Another possible user identity of “visitor (PIN)” may be associated with selected features that are not yet determined “TBD” 918 that could be correlated with assigned or available retroreflective devices 922 such as shared fixed location display device 928a and dedicated mobile device 928b. An applicable time limit might be “only in March” 938 along with a payment allocation status of “credit card pre-pay required” 948.

Ongoing variation of such data table entries illustrated in the data table of FIG. 30 may be implemented by supervisory personnel and/or by user interface requests to enable on-the-fly adjustment of user preferences and related viewing factors in order to provide desirable flexibility for changed circumstances.

Of course it will be understood that that the categories and data entries for the various user preferences and viewing factors shown in FIG. 30 are not intended to be exhaustive or otherwise limited, but are provided for purposes of illustration only and may be expanded or altered in some embodiments and may be shortened or omitted in other embodiments depending on the circumstances. It will be further understood that some retroreflective display devices may be adapted for usage by only one or more authorized users, and in other instances a retroreflective display device may be adapted for usage without any special authorization by individual or multiple users, depending on the type of display device as well as the nature of the textual or numerical or image or video representations displayed on the viewing screen.

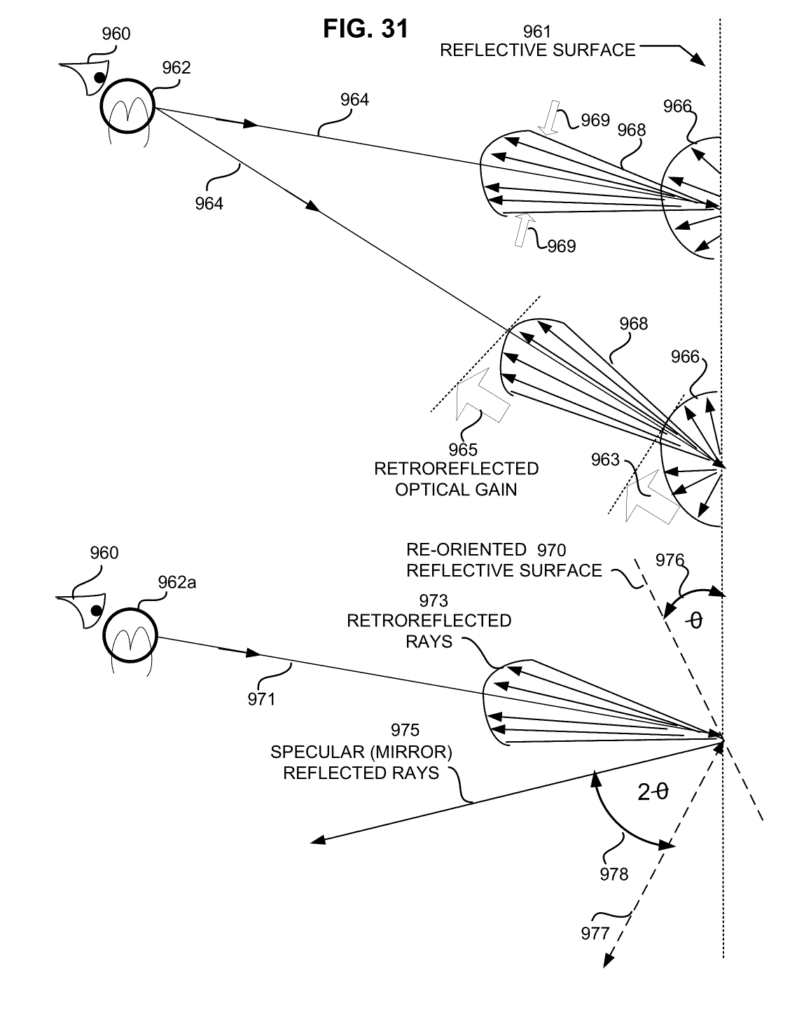

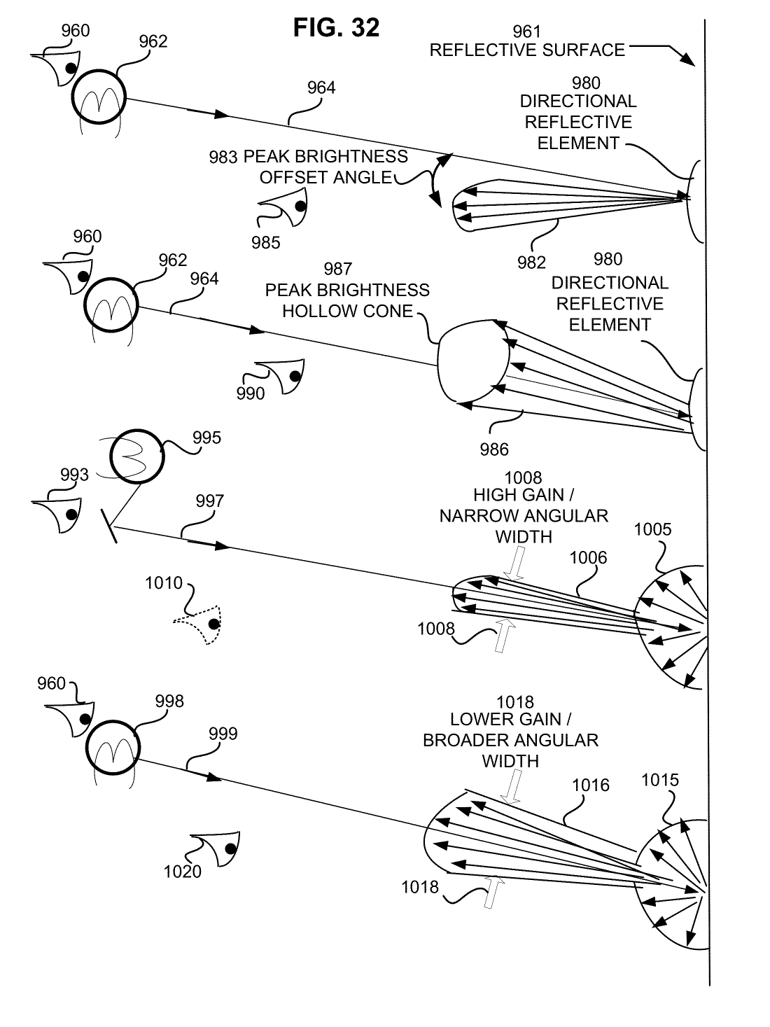

Referring to the schematic diagrams of FIGS. 31-32, various examples of retroreflective and specular techniques are shown which may be incorporated in visual displays that provide enhanced brightness and contrast for a user or observer situated at different preferred locations adjacent to an external retroreflective illumination source. As used herein the terms “retroreflector” and “retroreflective element” indicate an optical element which, when illuminated by one or more rays of light from a source, reflects a distribution of light which is brighter in the direction toward the light source than the corresponding distribution of light from a Lambertian (ideally diffuse) reflector. In that regard, FIG. 31 schematically illustrates a reflective surface 961 showing a diffusive distribution 966 of reflected light as compared to a limited angular spread 968 of brighter retroreflected light directed back toward an external light source 962 adjacent an eye 960 of a current user.

A retroreflective layer or retroreflective surface is understood to indicate a generally planar surface having retroreflective properties at each point on the surface. Such a surface is typically comprised of an array of small retroreflective elements. Typical retreflective elements include pyramidal prisms or corner cubes (three flat specular reflectors arranged at mutual ninety degree angles, like three sides of a cube) and “cat's eye” reflectors comprising a spherical lens placed over a spherical reflective surface. Those familiar with the art will be aware of other retroreflective optical configurations.

In a retroreflective embodiment having output light rays 971 generated by source 962a, the intensity of retroreflected light in the direction toward the source 962a is largely independent of the orientation of the retroreflective elements over some range of angles. For example, an intensity and direction of retroreflected rays 973 from retroreflective surface elements on surface 961 is not significantly altered with a re-orientated reflective surface 970 change of theta (see 976). This is in contrast to a simple mirror or “specular” reflector which reflects light primarily in a direction that depends on the orientation of the reflector (e.g., compare original angle of reflection for specular reflected rays 975 with altered angle change 978 for specular reflected rays 977 from the re-oriented reflective surface 970).

The gain of a retroreflector is the ratio of the peak brightness in a particular retroreflective distribution (see 965) to the corresponding brightness from a diffuse reflector (see 963). The angular spread of a retroreflector is the angular width (see 969) of the peak in distribution 968, measured at, e.g., the one-half maximum points. Note that angular width may be different in different directions, e.g., horizontal and vertical spread.

Referring to the schematic diagram of FIG. 32, a light source 995 that directs output light rays via mirror 996 along a path 997 toward a proximate retroreflective display enables an eye 993 of a user or observer to be directly aligned with a retroreflected light beam 1006 having a narrow angular width 1008. Such narrow angular width 1008 creates a high retroreflective gain for the user or observer (e.g., increased brightness of retroreflected light rays 1006 compared to a diffusive reflection 1005). Another consequence of such narrow angular width 1008 prevents a user whose eye 1010 is outside the angular spread of retroreflected light rays 1006 from obtaining the viewing benefit from the retroreflected clarity of images or text or video on the display screen.

As additionally shown in the schematic diagram of FIG. 32, a light source 962 directs output light rays along a path 999 toward a proximate retroreflective display that enables an eye 960 of a user or observer adjacent to the light source 962 to be within a viewing exposure to retroreflected light beam 1016 having a broader angular width 1018. Such broader angular width 1008 creates a lower retroreflective gain for the user or observer (e.g., somewhat increased brightness of retroreflected light rays 1006 compared to a diffusive reflection 1015). Another consequence of such broader angular width 1018 enables a user whose eye 1020 is outside the angular spread of retroreflected light rays 1006 to also obtain the viewing benefit from the retroreflected clarity of images or text or video on the display screen.

As illustrated in FIG. 32, the term “directional retroreflective element” is used herein (e.g., see also 271 in FIG. 2) to indicate an optical element which has properties similar to a retroreflector but does not have the peak of its reflected light distribution directly toward the light source 962. In some instances such a directional retroreflective element (see 980) may be helpful to laterally displaced user's eye (see 985, 990), but nevertheless cause a consequential result that deprives another user's eye 960, located closely adjacent to an optical axis of the light rays output 964, of any significant retroreflective benefit (e.g., enhanced brightness, improved contrast).

An exemplary embodiment shown in FIG. 32 shows a brightness peak for retroreflected rays 982 offset an angle (see 983) from the optical path of the output light rays 964 generated by the light source 962. However this offset can be used as a brightness or contrast viewing benefit for a user's eye 985 that is somewhat displaced from the optical path of light rays output 964. Another exemplary embodiment shown in FIG. 32 shows a brightness peak for retroreflected rays 986 in the form of a hollow cone 987 surrounding the optical path of output light rays 964 generated by the light source 962. However this offset can similarly be used as a brightness or contrast viewing benefit for a user eye 990 that is somewhat displaced from the optical path of light rays output 964.

The exemplary system, apparatus, and computer program product embodiments disclosed herein including FIGS. 1-6, FIGS. 15-19, and FIGS. 29-32, along with other components, devices, know-how, skill and techniques known in the art have the capability of implementing and practicing the methods and processes that are depicted in FIGS. 7-14 and FIGS. 20-28. However it is to be further understood by those skilled in the art that other systems, apparatus and technology may be used to implement and practice such methods and processes.

It will be understood by those skilled in the art that the various components and elements disclosed in the system and schematic diagrams herein as well as the various steps and sub-steps disclosed in the flow charts herein may be incorporated together in different claimed combinations in order to enhance possible benefits and advantages.

As shown and described herein, method and apparatus features are implemented in a visual display system to provide coordinated interaction between an independent light source and a proximate retroreflective display. The light rays output characteristics of the independent light source are adjusted (e.g., by a controller) based on predetermined and/or detected viewing parameters of the retroreflective display. The retroreflected rays are targeted back toward an eye of a user associated with the independent light source to provide improved brightness and contrast for screen viewing by the user. Some retroreflective display screen embodiments may also include a self-illuminating mode as well as other non-retroreflective illumination modes of operation.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1.-50. (canceled)

51. An illumination method for retroreflective displays, comprising:
activating an independent light source for illuminating one or more types of retroreflective displays; and
modifying at least one operating characteristic of the independent light source pursuant to analysis by a controller associated with the independent light source, wherein the analysis is based on a known or determined specified feature of a proximate retroreflective display.

52. The method of claim 51 wherein said activating the independent light source includes:
directing lights rays output from the independent light source toward one of the following types of proximate retroreflective displays: variably transmissive, backlit transmissive, emissive, specular variably reflective, diffuse variably reflective, self-illuminating, monochrome, color, alphanumeric display, image display, video display.

53. The method of claim 51 further comprising:
deactivating the independent light source in the absence of detecting the proximate retroreflective display sufficiently close to the independent light source.

54. The method of claim 51 further comprising:
initiate retroreflective viewing in response to detection of the proximate retroreflective display located sufficiently close to the independent light source.

55.-63. (canceled)

64. The method of claim 51 wherein said modifying at least one operating characteristic of the independent light source includes:
varying a specific directionality and/or angular distribution of light rays output directed toward the proximate retroreflective display.

65. The method of claim 64 further comprising:
providing a zoom lens or other optical component associated with the independent light source to vary the specific directionality and/or angular distribution of such light rays output.

66. The method of claim 64 wherein said activating an independent light source includes:
activating an array of light emitting elements to vary the specific directionality and/or angular distribution of such light rays output.

67. The method of claim 64 further comprising:
varying the specific directionality and/or angular distribution of such light rays output in response to user perception obtained via a user interface indicating appropriate targeting of the proximate retroreflective display.

68. The method of claim 64 further comprising:
automatically varying the specific directionality and/or angular distribution of such light rays output to match an apparent size and/or shape and/or perimeter of the proximate retroreflective display.

69. The method of claim 51 wherein said modifying at least one operating characteristic of the independent light source includes:
varying a specific directionality and/or angular distribution of light rays output from the independent light source based on the determination of one or more of the following specified features: type of display technology, fixed display location, mobile display device, stationary light source, moving light source.

70. The method of claim 51 further comprising:
determining via a micro-camera or sensor or other optical component associated with the independent light source one or more of the following viewing parameters of the proximate retroreflective display: solid angle subtended by the optical display, display screen size, display spatial orientation, optical viewing distance, display reflectivity, display spectral reflectivity, retroreflective optical gain, monochrome screen characteristics, color screen characteristics, display location, display motion.

71.-83. (canceled)

84. The method of claim 51 further comprising:
sending a recognizable encoded signal to the proximate retroreflective display to authorize one or more of the following functional features: optical display activation, content acceptance, content access, payment authorization, program application, video viewing, web-based email, Internet access, user preferences.

85. The method of claim 51 further comprising:
aiming an optical axis of light rays output from the independent light source toward the proximate retroreflective display.

86. The method of claim 85 wherein said aiming the optical axis of the light rays output includes:
incorporating a flexible or jointed or pivoting mount for mechanically aiming the independent light source or its related optical components toward the proximate retroreflective display.

87. The method of claim 85 wherein said aiming the optical axis of the light rays output includes:
directing light rays output toward the proximate retroreflective display via one or more of the following types of optical elements: tiltable micro-mirror, rotating wedge, pivotal lens, zoom lens, rays splitter, collimator, diffractive rays splitter, focusing lens, diffractive lens, reflector element, LED array, convergent/divergent array.

88. The method of claim 51 further comprising:
enable automatic determination of an optical gain of retroreflected light rays directed back to the user of the proximate retroreflective display.

89. The method of claim 51 further comprising:
enabling automatic or manual aiming of the independent light source or its related optical components toward the proximate retroreflective display.

90. The method of claim 51 wherein said activating the independent light source includes:
activating multiple individual light emitting elements to selectively illuminate different portions of an illuminated field of view of the proximate retroreflective display.

91. The method of claim 90 wherein said activating multiple individual light emitting elements includes:
activating at least one of the following types of individual light emitting elements: LED, laser, micro-fluorescent, VCSEL, OLED, field emission.

92. The method of claim 90 wherein said activating multiple individual light emitting elements includes:
selectively activating various combinations of the multiple individual light emitting elements.

93.-96. (canceled)

97. The method of claim 51 wherein said activating the independent light source includes:
enabling a mounting or support accessory separated from a user to position the independent light source at a relatively fixed location adjacent to the user.

98. (canceled)

99. (canceled)

100. The method of claim 51 further comprising:
determining respectively one or more specified features of different types of retroreflective display devices in a manner to automatically vary a specific directionality and/or angular distribution of light rays output to match an apparent size and/or shape and/or perimeter of each such different type of retroreflective display device.

101. A computer program product comprising computer-readable media having encoded instructions for executing an illumination method for retroreflective displays, wherein the method includes:
enabling an independent light source to provide light rays output for illuminating a proximate retroreflective display; and
implementing a modification of at least one operating characteristic of the independent light source based on a known or determined specified feature of the proximate retroreflective display.

102.-117. (canceled)

118. The computer program product of claim 101 wherein the method further includes:
automatically varying a specific directionality and/or angular distribution of the light rays output to match an apparent size and/or shape and/or perimeter of the proximate retroreflective display.

119. The computer program product of claim 101 wherein the method further includes:
varying a specific directionality and/or angular distribution of the light rays output based on one or more of the following characteristics: type of display technology, fixed display location, mobile display device, stationary illuminator unit, moving illuminator unit, stationary independent light source, moving independent light source.

120. The computer program product of claim 101 wherein the method further includes:
detecting and tracking retroreflected light rays in order to determine one or more of the following viewing parameters of the proximate retroreflective display: solid angle subtended by the optical display, display screen size, display spatial orientation, optical viewing distance, display reflectivity, display spectral reflectivity, retroreflective optical gain, monochrome screen characteristics, color screen characteristics, display location, display motion.

121.-150. (canceled)

151. An illumination system for use with a retroreflective display, comprising:
a light source;
a controller adapted to determine a characteristic of the retroreflective display, and
configured to control at least one operating characteristic of the light source in response to the characteristic of the retroreflective display.

152. The illumination system of claim 151 wherein said controller is configured to control a specific directionality of light rays output from the light source in response to a size and/or shape and/or perimeter of the retroreflective display.

153. The illumination system of claim 151 wherein said controller is configured to control an angular distribution of light rays output from the light source in response to a size and/or shape and/or perimeter of the retroreflective display.

154. The illumination system of claim 151 wherein said light source includes:
an independent light source located separately from the retroreflective display.

155. The illumination system of claim 151 wherein said controller is configured to be located separately from the retroreflective display.

156. The illumination system of claim 151 wherein said light source includes:
an independent light source mounted or attached at a fixed position relative to an eye of a user.

157. The illumination system of claim 151 wherein said controller is configured to achieve a preferred optical gain for retroreflected light directed toward a user.

158. The illumination system of claim 151 wherein said controller is configured to enable correlated interaction between the light source and multiple different types of retroreflective displays.

159. The illumination system of claim 151 wherein said controller is configured to enable correlated interaction between the light source and multiple types of retroreflective displays having respectively different variable retroreflective properties.

160. The illumination system of claim 151 wherein said controller is configured to enable correlated interaction between the light source and a designated retroreflective display adapted for implementing variable retroreflective properties in accordance with a particular set of user preferences.

161.-170. (canceled)

171. (canceled)

172. A retroreflective viewing system for a visual display comprising:
means for activating an independent light source;
means for determining a characteristic viewing factor of a proximate retroreflective display, and
controller means for adjusting at least one operating characteristic of the independent light source in response to the determined characteristic of the proximate retroreflective display.

173. The system of claim 172 wherein said controller means is configured to adjust a direction or angular distribution of light rays output from the independent light source based on a size and/or shape and/or perimeter of the proximate retroreflective display.

174. The system of claim 172 further comprising:
attachment means for positioning the independent light source at a relatively fixed location relative to an eye of a user of the proximate retroreflective display.

175. The system of claim 172 wherein said controller means is configured to enable a correlated interaction between the light source and a designated retroreflective display adapted for implementing variable retroreflective properties in accordance with a particular set of user preferences.
